(19) United States
(12) Patent Application Publication
(10) Pub. No.: US 2016/0275806 A1
(43) Pub. Date: Sep. 22, 2016

(54) LEARNING APPARATUS, LEARNING METHOD, AND NON-TRANSITORY COMPUTER READABLE STORAGE MEDIUM

(71) Applicant: YAHOO JAPAN CORPORATION, Tokyo (JP)

(72) Inventors: Kota TSUBOUCHI, Tokyo (JP); Teruhiko TERAOKA, Tokyo (JP)

(73) Assignee: YAHOO JAPAN CORPORATION, Tokyo (JP)

(21) Appl. No.: 14/976,739

(22) Filed: Dec. 21, 2015

(30) Foreign Application Priority Data
Mar. 18, 2015 (JP) 2015-055326

(51) Int. Cl. G09B 7/00; G09B 19/00

(52) U.S. Cl. CPC G09B 7/00; G09B 19/00

(57) ABSTRACT

A predicting apparatus according to the present application includes a correct answer generating unit and a second model generating unit. The correct answer generating unit generates correct answer information representing a response of each of one or more first targets to a given affair, based on a first model that is to be used for predicting the response to the affair, and on first information related to the first targets. The second model generating unit generates a second model that is to be used for predicting a response of each of one or more second targets corresponding to second information to the affair, the second information being information including information on one or more targets in addition to information on the first targets, based on the correct answer information generated by the correct answer generating unit, and on a part of the second information related to the first targets.

### CROSS-REFERENCE TO RELATED APPLICATION(S)

The present application claims priority to and incorporates by reference the entire contents of Japanese Patent Application No. 2015-055326 filed in Japan on Mar. 18, 2015.

### BACKGROUND OF THE INVENTION

1. Field of the Invention

The present invention relates to a learning apparatus, a learning method, and a non-transitory computer readable storage medium.

2. Description of the Related Art

Conventionally disclosed is a technology for generating a model that is used for predicting a response to a given affair based on information such as search logs that can be collected from many targets such as users.

However, such a conventional technology is not necessarily capable of accurately generating a model for predicting a response to a given affair. It is, for example, quite difficult to generate a model for predicting whether a user will make a certain action using log information on search queries such as simple keywords.

### SUMMARY OF THE INVENTION

It is an object of the present invention to at least partially solve the problems in the conventional technology.

According to one aspect of an embodiment, a learning apparatus includes a correct answer generating unit that generates correct answer information representing a response of each of one or more first targets to a given affair, based on a first model that is to be used for predicting the response to the affair, and on first information related to the first targets, and a second model generating unit that generates a second model that is to be used for predicting a response of each of one or more second targets corresponding to second information to the affair, the second information being information including information on one or more targets in addition to information on the first targets and having a lower correlation with the affair than the first information, based on the correct answer information generated by the correct answer generating unit, and on a part of the second information related to the first targets. The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic illustrating an example of a prediction process according to an embodiments;

FIG. 2 is a schematic of an example of a configuration of a predicting apparatus according to the embodiment;

FIG. 3 is a schematic illustrating an example of a first information storage unit according to the embodiment;

FIG. 4 is a schematic illustrating an example of a first model storage unit according to the embodiment;

FIG. 5 is a schematic illustrating an example of a second information storage unit according to the embodiment;

FIG. 6 is a schematic illustrating an example of a second model storage unit according to the embodiment;

FIG. 7 is a schematic illustrating an example of a first model generating process according to the embodiment;

FIG. 8 is a flowchart illustrating an example of the prediction process according to the embodiment;

FIG. 9 is a schematic illustrating an example of a prediction process according to a modification of the embodiment;

FIG. 10 is a schematic illustrating an example of how pieces of correct answer information are integrated in the modification;

FIG. 11 is a schematic illustrating an example of how the pieces of correct answer information are integrated in the modification;

FIG. 12 is a schematic illustrating an example of how the pieces of correct answer information are integrated in the modification;

FIG. 13 is a schematic illustrating an example of how the pieces of correct answer information are integrated in the modification;

FIG. 14 is a flowchart illustrating an example of a prediction process according to the modification; and

FIG. 15 is a schematic of a hardware configuration illustrating an example of a computer for implementing the functions of the predicting apparatus.

### DETAILED DESCRIPTION OF THE PREFERRED EMBODIMENTS

Some embodiments of a learning apparatus, a learning method, and a learning program according to the present application (hereinafter, referred to as an “embodiment”) will now be explained in detail with reference to some drawings. These embodiments are not intended to limit the scope of the learning apparatus, the learning method, and the learning program according to the present application in any way. The parts shared among the embodiments described hereunder will be assigned with the same reference numerals, and redundant explanations thereof are omitted herein.

### Embodiment

1. Prediction Process

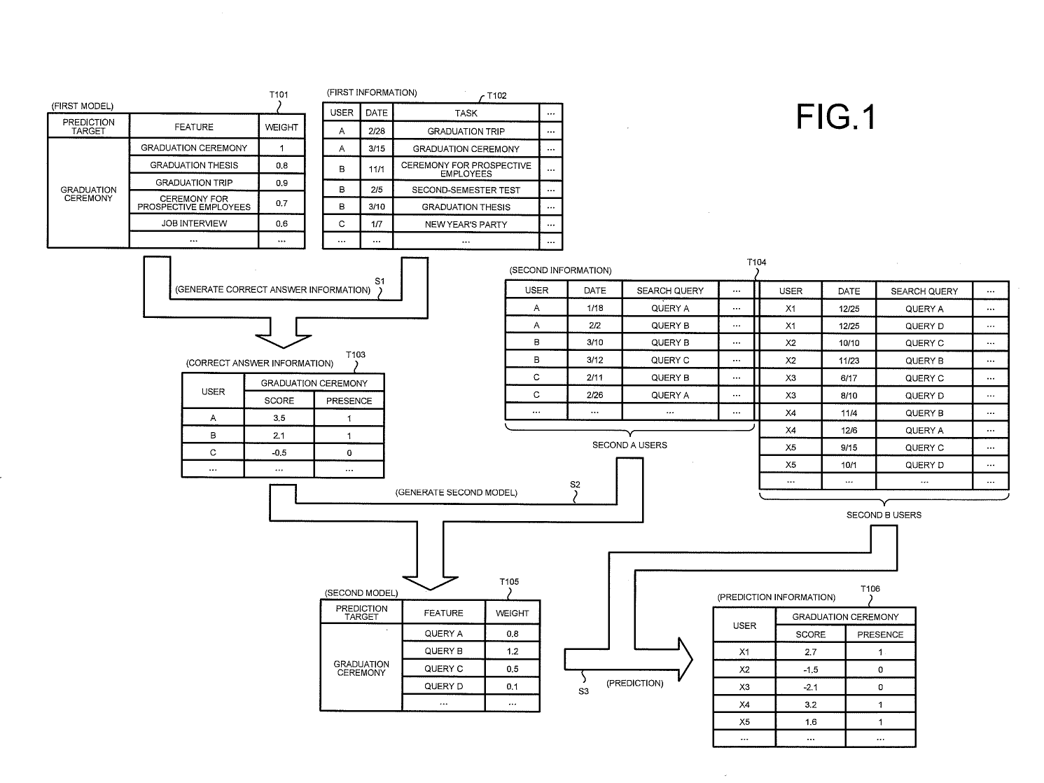

An exemplary prediction process according to the embodiment will now be explained with reference to FIG. 1. FIG. 1 is a schematic illustrating an example of a prediction process according to the embodiment. In the example described below, targets are explained to be users. First targets are described to be first users, and second targets are described to be second users. The targets are, however, not limited to users, and may be any targets from which information can be collected, such as cities, products, and services. A predicting apparatus 100 uses calendar information that is information related to the schedule of activities of a user as first information. In the description below, users corresponding to the first information are referred to as first users. Explained in FIG. 1 is an example in which the first model is generated in advance. The first model may also be generated using the first information, and an example in which the first model is generated using the first information will be described later. The first model is a model that is applicable to the first information, and that enables a response of a first user to a given affair (hereinafter, sometimes referred to as a “prediction target”) to be determined based on the first information.

The predicting apparatus 100 also uses the information related to the history of search queries that are search log information as the second information. In this manner, in the example illustrated in FIG. 1, the predicting apparatus 100 uses another type of information that is different from the first information as the second information. In the description below, users corresponding to the second information are referred to as second users. The second users include at least one or more first users. The second users also include at least one or more users other than the first users. In the description below, the second users who are also the first users are sometimes referred to as second A users, and the second users who are not the first user are sometimes referred to as second B users.

Explained with reference to FIG. 1 is an example in which a response to a prediction target is participation of a user to a graduation ceremony. In the example described below, an action of a user that is the participation to the graduation ceremony that is the prediction target is the prediction target, and the predicting apparatus 100 predicts whether such an action will take place, that is, predicts a response to the prediction target. In other words, when a user participates to the graduation ceremony, the action is present, and when the user does not participate in the graduation ceremony, the action is absent. Hereinafter, the participation to the graduation ceremony that is the prediction target is sometimes referred to as a prediction target “graduation ceremony”. Furthermore, hereinafter the “presence of an action” may be simply referred to as “presence”. The “presence of an action” may be simply referred to as being “present”, and the “absence of an action” may be simply referred to as being “absent”.

Explained in FIG. 1 is an example in which the predicting apparatus 100 predicts whether the second users from whom only search log information has been collected, that is, the second B users will participate to a graduation ceremony, based on the information on the first users whose calendar information has been collected.

To begin with, the predicting apparatus 100 generates correct answer information based on the first information and the first model (Step S1). In the example illustrated in FIG. 1, the predicting apparatus 100 generates correct answer information T103 based on a first model T101 generated in advance and first information T102. In the example illustrated in FIG. 1, the first model T101 includes an element (hereinafter, referred to as a “feature”) mapped to a prediction target “graduation ceremony”, and a weight value (hereinafter, simply referred to as a “weight”) representing a degree of impact that the feature has on the prediction target “graduation ceremony”. For example, in the example illustrated in FIG. 1, a feature “graduation ceremony” has a weight of “1”, and a feature “graduation thesis” has a weight of “0.8”. In this manner, a feature with a larger impact on the prediction target “graduation ceremony” is assigned with a greater weight. When the predicting apparatus 100 generates the first model, for example, the predicting apparatus 100 generates the first model T101 based on the first information T102 corresponding to the users of which participation to the graduation ceremony have been determined, but this process will be described later in detail. In the example illustrated in FIG. 1, the first information T102 is calendar information, and includes information such as user names, dates indicating a schedule, and the details of the schedule such as tasks.

The correct answer information T103 generated at Step S1 will now be explained. In the example illustrated in FIG. 1, the tasks in the first information T102 correspond to the identities in the first model T101, and the correct answer information indicating whether each user has a prediction target “graduation ceremony” is generated based on a calculated value calculated from the feature included in the task of the user and the weight of the feature (hereinafter, sometimes referred to as a “score”). For example, the tasks of a user A include those with a feature “graduation trip” and a feature “graduation ceremony”, for example, and so, the score of the user A will be “0.9+1+ . . . =3.5”. This score calculation will be described later in detail.

In the example illustrated in FIG. 1, if the score is greater than zero, the predicting apparatus 100 determines that the prediction target “graduation ceremony” is present, and if the score is equal to or less than zero, the predicting apparatus 100 determines that the prediction target “graduation ceremony” is absent. In the correct answer information T103, the presence “1” specifies the presence of the prediction target, and the presence “0” specifies the absence of the prediction target. In other words, in the correct answer information T103, a user with the presence “1” is a user expected to participate to a graduation ceremony, and a user with the presence “0” is a user not expected to participate to a graduation ceremony. In the correct answer information T103, the user A and the user B having scores greater than zero are users determined to have a prediction target “graduation ceremony”, and a user C having a score less than zero is a user determined not to have a prediction target “graduation ceremony”.

In this manner, at Step S1, the predicting apparatus 100 generates the correct answer information T103 indicating whether each of the first users corresponding to the first information has the prediction target “graduation ceremony”, based on the first model T101 and the first information T102.

The predicting apparatus 100 then generates a second model based on the correct answer information and the second information (Step S2). Specifically, the predicting apparatus 100 generates the second model based on the correct answer information and the second information corresponding to the second A users. In the example illustrated in FIG. 1, the predicting apparatus 100 generates the second model T105 based on the correct answer information T103 generated at Step S1 and the second information T104. In the example illustrated in FIG. 1, the second information T104 is search log information, and includes information such as user names, dates of search, and search queries used in the searches. In the example of the second model T105 generated at Step S2 illustrated in FIG. 1, search queries that are the identities are mapped to the prediction target “graduation ceremony”, and each of the search queries has a weight indicating a degree of impact the search query has on the prediction target “graduation ceremony”. In other words, the predicting apparatus 100 derives a weight indicating a degree of impact that the search query that is a feature has on the prediction target “graduation ceremony” through a learning process, based on the correct answer information T103 and the second information T104. The learning process for generating the second model will be described later in detail. The second model is a model that is applicable to the second information, and that enables a response of a second user to a prediction target to be determined based on the second information, the response being a prediction target.

At this time, the predicting apparatus 100 generates the second model using the second information corresponding to the correct answer information, that is, the second information corresponding to the first users. In the example illustrated in FIG. 1, the second information T104 includes users that are not the first users corresponding to the first information T102. For example, the second information T104 includes a user X who is not included in the first users corresponding to the first information T102. The predicting apparatus 100 generates the second model T105 based on the correct answer information and the part of the second information T104 corresponding to the first users. For example, the predicting apparatus 100 generates the second model T105 based on the correct answer information and the second information T104 corresponding only to the users A, B, and C. In other words, the predicting apparatus 100 generates the second model T105 based on the second information T104 excluding the information corresponding to the users X1 to X5, and so on who are not included in the first users. In other words, the predicting apparatus 100 generates the second model T105 using the second information T104 corresponding to the second A users.

The second model T105 generated at Step S2 includes identities (search queries) mapped to the prediction target “graduation ceremony”, and weights indicating degrees of impact the respective identities have on the prediction target “graduation ceremony”. For example, in the example illustrated in FIG. 1, the feature “query A” has a weight of “0.8”, and the feature “query B” has a weight of “1.2”. In this manner, a feature with a larger impact on the prediction target “graduation ceremony” is assigned with a greater weight.

The predicting apparatus 100 then generates prediction information T106 for predicting whether the second users corresponding to the second information T104 have the prediction target “graduation ceremony”, using the second model T105 (Step S3). In the example illustrated in FIG. 1, the predicting apparatus 100 generates the prediction information T106 for predicting whether each of the second B users has the prediction target “graduation ceremony”, using the second model T105. For example, the predicting apparatus 100 generates the prediction information T106 for predicting whether the user X1 has the prediction target “graduation ceremony”, using the second information T104 corresponding to the user X1 and the second model T105.

Specifically, the search queries belonging to the user X1 include those with a feature “query A”, a feature “query D”, and the like, and the score of the user X1 is calculated as “0.8+0.1+ . . . =2.7”. In the example illustrated in FIG. 1, the predicting apparatus 100 then determines that the prediction target “graduation ceremony” is present if the score is greater than zero, and determines that the prediction target “graduation ceremony” is absent if the score is less than zero. If the score is greater than zero in the prediction information T106, the user “X1” is determined to have a prediction target “graduation ceremony”. The predicting apparatus 100 also generates the prediction information T106 for predicting whether each of the users X2 to X5, and so on who are the other second B users has a prediction target “graduation ceremony”. The predicting apparatus 100 may also determine whether a user has a prediction target “graduation ceremony” based on a relation between the score and a predetermined threshold. For example, the predicting apparatus 100 may determine that the prediction target “graduation ceremony” is present if the score is equal to or greater than the threshold “2”, and may determine that the prediction target “graduation ceremony” is absent if the score is less than the threshold “2”. The predicting apparatus 100 may also perform a process corresponding to what is called a multi-label problem which handles three or more values, without limitation to the binary taking a value of either “0” or “1”. For example, the predicting apparatus 100 may also predict to which one of three or more classes the user belongs, instead of two classes of responses each of which indicates either the response to the prediction target is present or absent. For example, the predicting apparatus 100 may also predict to which one of classes of the responses to a prediction target the user belongs using a plurality of thresholds. Specifically, the predicting apparatus 100 may use a first threshold and a second threshold that is smaller than the first threshold, and determine that the user is highly likely to take the response to the prediction target if the score is equal to or greater than the first threshold, determine that the user is somewhat likely to take the response to the prediction target if the score is less than the first threshold but is equal to or greater than the second threshold, and determine that the user is not likely to take the response to the prediction target if the score is less than the second threshold.

In this manner, the predicting apparatus 100 according to the embodiment can generate a model used for predicting a response to a prediction target, that is, for predicting whether a user will take the action highly accurately. Specifically, the predicting apparatus 100 generates the correct answer information related to the first users corresponding to the first information, using the calendar information having a higher correlation with user actions, being higher than the correlation the search log information has, as the first information. As described above, the correct answer information is information enabling a response of a first user to a prediction target to be determined. The predicting apparatus 100 also generates the second model using the correct answer information and the part of the second information corresponding to the first users. In this manner, because the second model is generated using the correct answer information that is generated from the first information highly correlated with actions of the users, the resultant second model can be applied to all of the second users corresponding to the second information, and is capable of predicting the response to a prediction target accurately. The predicting apparatus 100 can thus generate a model used for predicting a response to a prediction target highly accurately. Furthermore, the predicting apparatus 100 can predict a response to a prediction target highly accurately by applying the second model to the second users. In other words, the predicting apparatus 100 can predict a response of each of the second users other than the first users, that is, a response of each of the second B users to a prediction target highly accurately.

Furthermore, as in the example illustrated in FIG. 1, a smaller amount of data can be collected from the calendar information, compared with that collectable from search log information. Furthermore, the users from whom the calendar information can be collected are limited, compared with the search log information. The first information having a higher correlation with the prediction target than the second information often has a smaller amount of collectable data or a smaller number of users compared with the second information. In other words, the second information permits data less correlated with the prediction target compared with the first information to be collected from a larger number of users. Given such a condition, the predicting apparatus 100 can generate the second model for enabling a response of a second user not included in the first users, that is, a second B user, to a prediction target to be predicted, based on the correct answer information generated from the first information, and the part of the second information related to the first users. In other words, the predicting apparatus 100 can generate a model enabling a highly accurate prediction of a response to a prediction target based on the second information having a lower correlation with the prediction target. Therefore, the predicting apparatus 100 can also generate a model for enabling a highly accurate prediction of a response of a user from whom the first information, which is highly correlated with the prediction target, cannot be collected, that is, a second user who is a second B user not included in the first users to a prediction target. Furthermore, in the example illustrated in FIG. 1, information linked to a given affair serving as the prediction target is used as the first information. Specifically, in the example illustrated in FIG. 1, the prediction target is an action of a user. In the example illustrated in FIG. 1, the predicting apparatus 100, therefore, uses the calendar information that is the information related to the schedule of user's activities, as the first information. As mentioned earlier, the calendar information is information related to the schedule of user's activities. In other words, the first information that is the calendar information is information that can be linked to a user's action that is the prediction target. In other words, the first information that is the calendar information is information closely related to a user's action that is the prediction target. Therefore, with the first information that is the calendar information, a user's action that is the prediction target can be predicted highly accurately. The degree by which the information is linked to a given affair that is the prediction target varies depending on some events. In other words, some information that can be used as the first information linked to a predetermined event may not be linked to another predetermined event, and may not be able to be used as the first information. In other words, a piece of information may or may not serve as the first information depending on the given affair that is the prediction target. In other words, information serving as the first information and information not serving as the first information are relatively determined. For example, assuming that a given affair is a prediction target as to whether a user is to enter a particular search query, the search log information that is used as the second information in the example illustrated in FIG. 1 may be used as the first information.

As described above, the number of users from whom the first information can be collected is often greater than those from whom the second information can be collected. In other words, the number of the second users from whom only the information having a lower correlation with the prediction target can be collected is greater than the number of the first users from whom information having a higher correlation with the prediction target can be collected. In other words, to explain using a relation within the second users, there are much more second B users who are not the first users, than the second A users who are also the first users. Therefore, by learning based on the information on a smaller number of users enabling a highly accurate prediction of a response to a prediction target, the predicting apparatus 100 can predict a response to a prediction target highly accurately, for a much large number of users for whom a highly accurate prediction of a response to a prediction target has been rendered difficult. When the prediction target is a predetermined action, for example, the predicting apparatus 100 may establish a predetermined time period suitable for the prediction target, e.g., one week or three months, from when the predicting apparatus 100 makes the prediction. Furthermore, the predicting apparatus 100 may also establish a predetermined time period suitable for the prediction target, e.g., one week or three months, from when the second model is generated.

2. Configuration of Prediction Apparatus

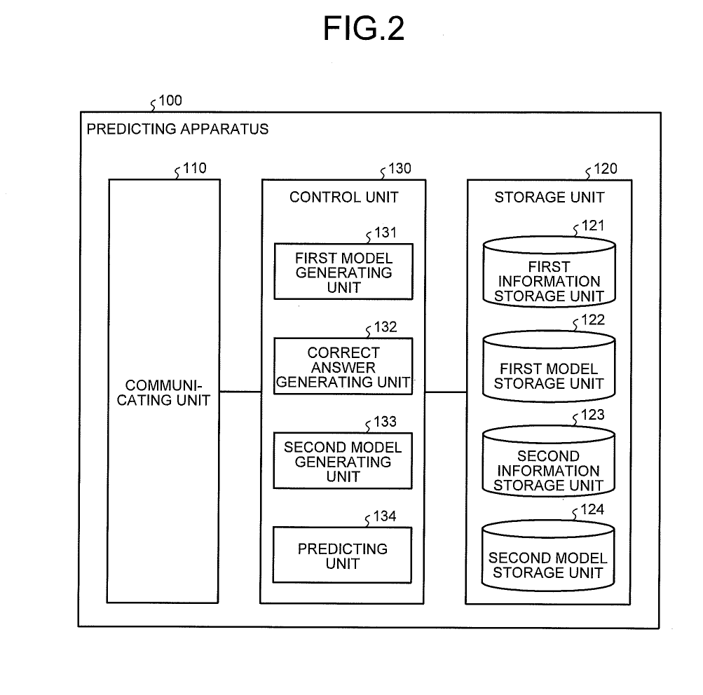

A configuration of the predicting apparatus 100 according to the embodiment will now be explained with reference to FIG. 2. FIG. 2 is a schematic of an example of the configuration of the predicting apparatus 100 according to the embodiment. The predicting apparatus 100 is a learning apparatus that generates the correct answer information from the first model and the first information, and generates the second model from the generated correct answer information and the second information. The predicting apparatus 100 also makes a prediction related to a prediction target for a second user based on the generated second model. As illustrated in FIG. 2, the predicting apparatus 100 includes a communicating unit 110, a storage unit 120, and a control unit 130. The predicting apparatus 100 may also include a display unit for displaying various types of information, and an input unit for inputting various types of information.

The communicating unit 110 is implemented as a network interface card (NIC), for example. The communicating unit 110 is connected to a predetermined network over a wire or wirelessly, and exchange information with external information processing apparatuses.

Storage Unit 120

The storage unit 120 is implemented as a storage device such as a random access memory (RAM), a semiconductor memory device such as a flash memory, a hard disk, or an optical disk. The storage unit 120 according to the embodiment includes, as illustrated in FIG. 2, a first information storage unit 121, a first model storage unit 122, a second information storage unit 123, and a second model storage unit 124.

First Information Storage Unit 121

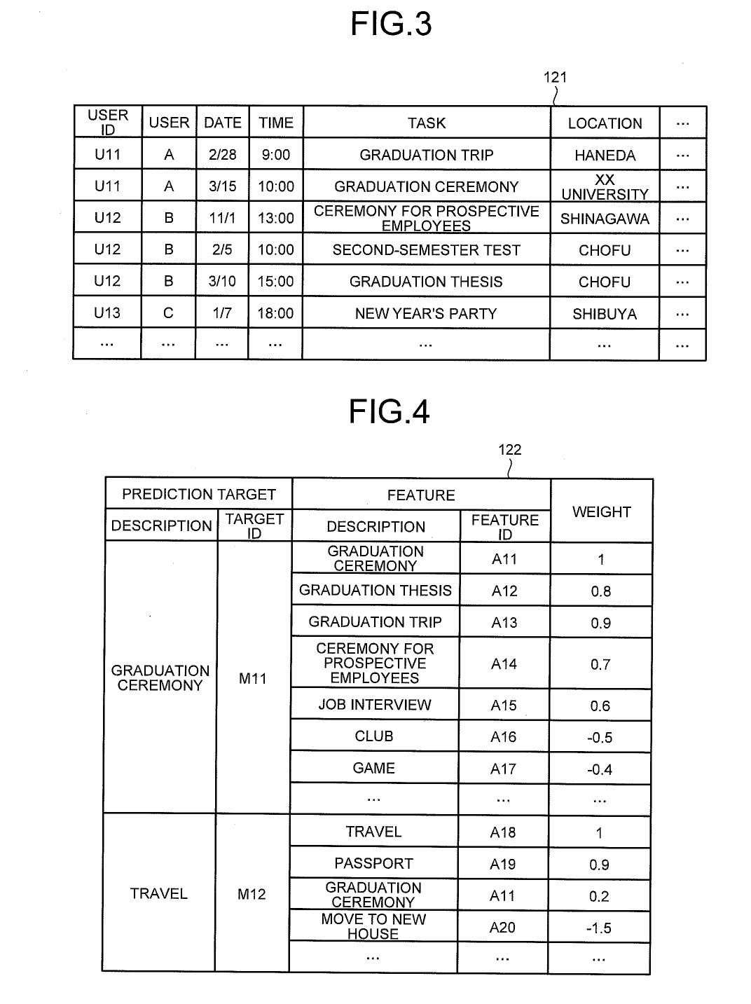

The first information storage unit 121 according to the embodiment stores therein the first information used for generating the correct answer information. FIG. 3 illustrates an example of the first information stored in the first information storage unit 121. In the example illustrated in FIG. 3, calendar information on the first users is stored as the first information. As illustrated in FIG. 3, the first information storage unit 121 includes items such as “user ID”, “user”, “date”, “time”, “task”, “location” . . . , as the first information. These items are, however, not limited to those listed above, and the first information storage unit 121 may also include various types of items suitable for the purpose, such as an item for information on other users related to the tasks, e.g., users making the action together.

The “user ID” indicates identification information for identifying a user. The “user” stores therein a user name identified by the corresponding user ID. For example, the example illustrated in FIG. 3 indicates that the user identified by a user ID “U11” is a user “A”, and that the user identified by a user ID “U12” is a user “B”.

The “date” indicates a date related to a corresponding task registered by a user. The “time” indicates the time related to the task registered by the user. The “task” indicates information related to a schedule registered by the user. The “location” indicates a location related to the task registered by the user.

For example, the example illustrated in FIG. 3 indicates that the user “A” has a task “graduation trip” at 9 o'clock on February 28, and the location is “Haneda”, and also indicates that the user “B” has a task “ceremony for prospective employees” at 13 o'clock on November 1, and the location is “Shinagawa”, for example. Explained above is an example in which the user him/herself registers entries such as a date and a task, but the date and the task may be registered automatically, using some function of a terminal device or the like owned by the user, without causing the user to register. Furthermore, the date may also store therein information related to a year, e.g., in the western calendar or the Japanese calendar.

First Model Storage Unit 122

The first model storage unit 122 according to the embodiment is a model used for predicting a response to a given affair, and stores therein information related to the first model that is applicable to the first users (first information). FIG. 4 illustrates an example of user classification information stored in the first model storage unit 122. As illustrated in FIG. 4, the first model storage unit 122 includes items such as “prediction target”, “feature”, “weight” . . . , as the first model.

The “prediction target” includes “description” and “target ID”. The “description” provides a description of an affair that is to be a prediction target, and the “target ID” indicates identification information for identifying the prediction target. For example, in the example illustrated in FIG. 4, the prediction target “graduation ceremony” is identified by a target ID “M11”, and a prediction target “travel” that is to be a prediction target is identified by a target ID “M12”.

The “feature” includes “description” and “feature ID”. The “description” provides a description of the feature, and the “feature ID” indicates identification information for identifying the corresponding feature. For example, in the example illustrated in FIG. 4, the feature “graduation ceremony” is identified by a feature ID “A11”, and the feature “graduation thesis” is identified by a feature ID “A12”. In the example illustrated in FIG. 4, the feature “graduation ceremony” corresponding to the prediction target “graduation ceremony” has a weight of “1”, and the feature “graduation ceremony” corresponding to the prediction target “travel” has a weight of “0.2”. The same feature is thus assigned with different weights if the prediction targets correspond to the feature are different. The feature “graduation ceremony” corresponding to the prediction target “graduation ceremony” and the feature “graduation ceremony” corresponding to the prediction target “travel” may also be assigned with different feature IDs. Furthermore, in the example illustrated in FIG. 4, a feature “club” has a weight of “−0.5”, and a feature “game” has a weight of “−0.4” for the prediction target “graduation ceremony”. In this manner, identities may be assigned with a negative weight.

Second Information Storage Unit 123

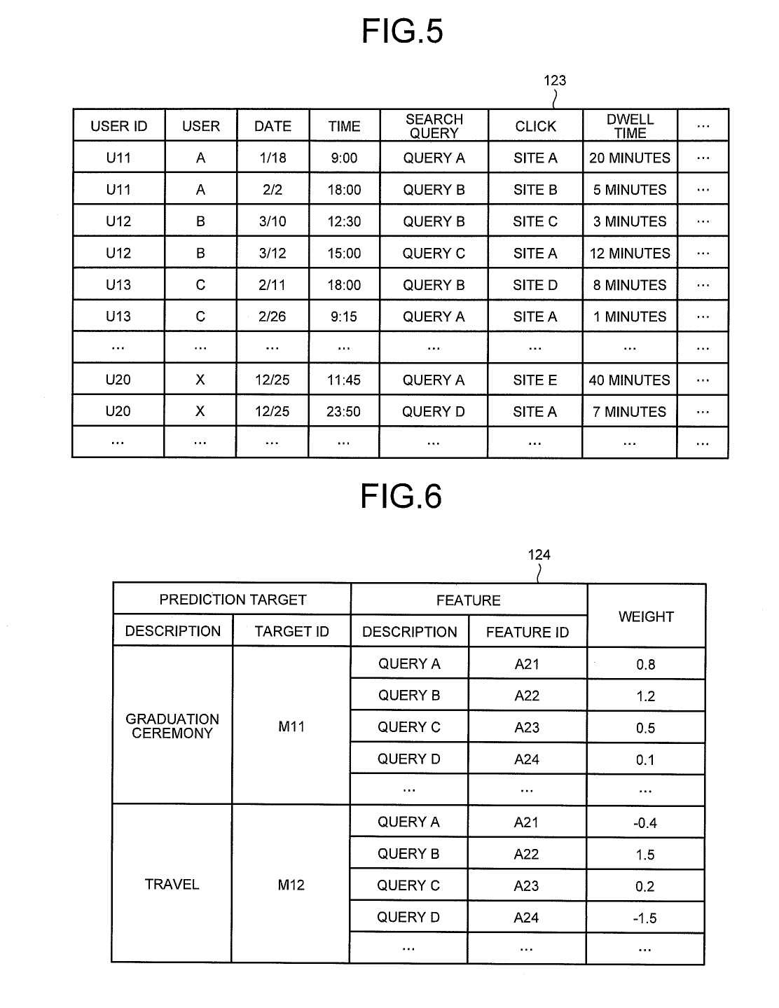

The second information storage unit 123 according to the embodiment stores therein the first information used for generating the correct answer information. FIG. 5 illustrates an example of the first information stored in second information storage unit 123. In the example illustrated in FIG. 5, the calendar information on the first users is stored as the first information. As illustrated in FIG. 5, the second information storage unit 123 includes items such as “user ID”, “user”, “date”, “time”, “search query”, “click”, “dwell time”, . . . as the first information. These items are, however, not limited to those listed above, the second information storage unit 123 may also include various types of items suitable for the purpose.

The “user ID” indicates identification information for identifying a user. The “user” stores therein a user name identified by the corresponding user ID. For example, the example illustrated in FIG. 5 indicates that the user identified by a user ID “U11” is a user “A”, and that the user identified by a user ID “U12” is a user “B”, for example. The example illustrated in FIG. 5 also indicates that the user identified by a user ID “U20” is a user “X”. In the example illustrated in FIG. 5, the user “A” and the user “B” are users included in the first users corresponding to the first information illustrated in FIG. 3, and the user “X” are users who are not included in the first users corresponding to the first information illustrated in FIG. 3.

The “date” indicates the date on which the user has executed a search with the search query. The “time” indicates the time at which the user has executed the search with the search query. The “search query” indicates the search query used in the search executed by the user. The “click” indicates the search result on which the user has clicked, among the search results acquired by the search query. The “dwell time” indicates the dwell time for which the user has spent on the site to which the user has transited as a result of clicking on the search result.

For example, the example illustrated in FIG. 5 indicates that the user “A” has executed a search with a search query “query A” at 9 o'clock on January 18. This example also indicates that the user “A” clicks on a “site A” among the search results returned to the search query “query A” at 9 o'clock on January 18, and have spent “20 minutes” on the site A. This example also indicates that, as an example, the user “B” has executed a search with a search query “query B” at twelve thirty on March 10, and that the user “B” clicks on a “site C” among the search results returned to the search query “query B” at twelve thirty on March 10, and have spent “3 minutes” on the site C. The date may also store therein information related to a year, e.g., in the western calendar or the Japanese calendar.

Second Model Storage Unit 124

The second model storage unit 124 according to the embodiment is a model used for predicting a response to a given affair, and stores therein information related to the second model that is applicable to the second users (second information). FIG. 6 illustrates an example of user classification information stored in the second model storage unit 124. As illustrated in FIG. 6, the second model storage unit 124 includes items such as “prediction target”, “feature”, “weight” . . . , as the second model.

The “prediction target” includes “description” and “target ID”. The “description” provides a description of an affair that is to be a prediction target, and the “target ID” indicates identification information for identifying the prediction target. For example, in the example illustrated in FIG. 6, the prediction target “graduation ceremony” is identified by a target ID “M11”, and the prediction target “travel” that is to be a prediction target is identified by a target ID “M12”.

The “feature” includes “description” and “feature ID”. The “description” provides a description of the feature, and the “feature ID” indicates identification information for identifying the feature. For example, in the example illustrated in FIG. 6, the feature “query A” is identified by a feature ID “A21”, and the feature “query B” is identified by a feature ID “A22”. In the example illustrated in FIG. 6, the feature “query A” has a weight of “0.8” on the prediction target “graduation ceremony”, and the feature “query A” has a weight of “−0.4” on the prediction target “travel”. The feature “query A” for the prediction target “graduation ceremony” may be assigned with a feature ID that is different from that assigned to the feature “query A” for the prediction target “travel”.

Control Unit 130

Returning to the description of FIG. 2, the control unit 130 is implemented by, for example, causing a central processing unit (CPU), an micro-processing unit (MPU), or the like, to execute various computer programs (corresponding to an example of a prediction program) stored in an internal storage device provided to the predicting apparatus 100, using a random access memory (RAM) as a working area. The control unit 130 is implemented as an integrated circuit such as application specific integrated circuit (ASIC) or a field-programmable gate array (FPGA).

As illustrated in FIG. 2, the control unit 130 includes a first model generating unit 131, a correct answer generating unit 132, a second model generating unit 133, and a predicting unit 134, and implements or executes the functions and the actions of the information processing which will be explained below. The internal configuration of the control unit 130 is not limited to that illustrated in FIG. 2, and may be any other configurations performing the information processing which will be described later. The connections of the processing units included in the control unit 130 are not limited to those illustrated in FIG. 2, and may be any other connections. Furthermore, the control unit 130 may also include a receiving unit if the control unit 130 is configured to receive various types of information such as the first model and the first information from an external information processing apparatus, for example. The control unit 130 may also include a transmitting unit if the control unit 130 is configured to transmit information such as the second model or the prediction information to an external information processing apparatuses, for example.

First Model Generating Unit 131

The first model generating unit 131 generates the first model based on various types of information. In the embodiment, the first model generating unit 131 generates the first model using the first information, in a manner which will be described later in detail.

Correct Answer Generating Unit 132

The correct answer generating unit 132 generates the correct answer information indicating responses of the first users to some affairs, based on the first information and the first model. In the example illustrated in FIG. 1, the correct answer generating unit 132 generates the correct answer information T103 based on the first model T101 and the first information T102. Generation of the correct answer information will now be explained using the example of the first model T101, the first information T102, and the correct answer information T103 illustrated in FIG. 1. To begin with, the correct answer generating unit 132 calculates a score from the correct answer information using Equation (1) below.

y=w₁×x₁+w₂+x₂+ . . . +wₙ×xₙ (1)

Equation (1) can be expressed as Equation (2) below, as an equation using a symbol “Σ (sigma)”. It is assumed hereunder that, an equation using a symbol “Σ (sigma)”, e.g., Equation (2) below, is expressed in the format of Equation (1) above.

$$y = {\sum }_{i = 1}^{n} {w}_{i} \times {x}_{i} \qquad ( 2 )$$

“x₁” to “xₙ” in Equation (2) represent whether any feature is included in the first information corresponding to each of the first users. “n” corresponds to the number of identities included in the first model. Each of “x₁” to “xₙ” in Equation (2) is assigned with “1” when the first information includes the corresponding feature, and is assigned with “0” when the first information does not include the corresponding feature. For example, “x₁” indicates whether the task “graduation ceremony” is included in the first information T102 for the corresponding user, and “x₂” indicates whether the task “graduation thesis” is included in the first information T102 for the corresponding user. “x₃” indicates whether the task “graduation trip” is included in the first information T102 for the corresponding user.

“w₁” to “wₙ” in Equation (2) represent the weights given to “x₁” to “xₙ”, respectively. For example, “w₁” represents a weight given to “x₁ (graduation ceremony)”, and “w₂” represents a weight given to “x₂ (graduation thesis)”. “w₃” represents a weight given to “x₃ (graduation trip)”.

For example, in the first information T102 illustrated in FIG. 1, the user “A” is registered with a task corresponding to the feature “graduation ceremony” that corresponds to “xᵢ”, and to the feature “graduation trip” that corresponds to “x₃”. Therefore, the score of the user “A2” is calculated as “y=1×1+0.8×0+0.9×1+ . . . ”, by substituting its variables in Equation (2) with the actual values. For example, in the example illustrated in FIG. 1, the score of the user “A” is calculated as “y=3.5”, and the score of the user “B” is calculated as “y=2.1”. The score of the user “C” is calculated as “y=−0.5”.

The correct answer generating unit 132 then generates information indicating the presence of a prediction target based on the scores calculated with Equation (2). The correct answer generating unit 132 generates information indicating the presence of a prediction target from Equation (3) below.

z=sgn(y) (3)

Where “sgn” in Equation (3) is a sign function that returns either “1” or “−1”, depending on the sign of the real number. For example, “b=sgn(a)” returns “b=1” if “a≧0”, and returns “b=−1” if “a<0”. In other words, in Equation (3), if the value of “y” calculated by Equation (1) is equal to or more than “0”, this function will return “1” for “z”, and if “y” is less than “0”, the function will return “−1” for “z”. “z” in Equation (3) serves as the information indicating the presence of the prediction target. If the sign function “sgn” returns “b=0” when “a=0”,“b=0” may be replaced with either “b=1” or “b=−1” before the value is processed.

The correct answer generating unit 132 generates information indicating the presence of a prediction target by substituting “y” in Equation (3) with the scores for the respective user “A”, “B”, “C”, and so on calculated by Equation (2). Specifically, as indicated in the correct answer information T103 in FIG. 1, the correct answer generating unit 132 generates “1” indicating that the user “A” and the user “B” have the prediction target, and generates “0” indicating that the user “C” do not have the prediction target, as the correct answer information.

Second Model Generating Unit 133

The second model generating unit 133 generates the second model that is used for predicting a response of each of the second users corresponding to the second information to an affair, based on the correct answer information generated by the correct answer generating unit 132 and the part of the second information related only to the first users, among the entire information that also includes that of the users other than the first users, and that has a lower correlation with an affair than the first information. In the example illustrated in FIG. 1, the second model generating unit 133 generates the second model T105 based on the correct answer information T103 and the second information T104. The following explanation will be provided using the correct answer information T103, the second information T104, and the second model T105 illustrated in FIG. 1 as an example. The second model generating unit 133 calculates the second model using Equation (4) below.

$$sgn ( {\sum }_{i = 1}^{n} {w}_{i} \times {x}_{i} ) = {\sum }_{j = 1}^{{n}^{′}} {w}_{j}^{′} \times {x}_{j}^{′} \qquad ( 4 )$$

“wᵢ” and “xᵢ” on the left-hand side of Equation (4) are the same as those in Equation (2). “x′₁” to “x′_{n′}” on the right-hand side of Equation (4) represent numbers indicating whether the respective identities are included in the first information corresponding to each of the first users. n′ corresponds to the number of identities included in the second model. In other words, n′ corresponds to the number of identities for which the weight is to be calculated when the second model is generated. The second model generating unit 133 may determine the number and the content of the identities based on a predetermined condition. Each of “x′₁” to “x′_{n′}” in Equation (4) is assigned with “1” when the first information includes the corresponding feature, and assigned with “0” when first information does not include the feature. For example, “x′₁” indicates whether the search query “query A” is included in the second information T104 of the corresponding user, and “x′₂” indicates whether the search query “query B” is included in the second information T104 of the corresponding user. “x′₃” indicates whether the search query “query C” is included in the second information T104 of the corresponding user. The number of times the corresponding feature (query) is used may also be assigned to “x′₁” to “x′_{n′}”.

In Equation (4), “w′₁” to “w′_{n′}” represent the weights given to “x′₁” to “x′_{n′}”, respectively. For example, “w′₁” represents a weight given to “x′₁ (query A)”, and “w′₂” represents a weight given to “x′₂ (query B)”. “w′₃” represents a weight given to “x′₃ (query C)”.

The second model generating unit 133 generates the second model through the learning process. Specifically, the second model generating unit 133 acquires a combination of the weights “w′₁” to “w′_{n′}” satisfying Equation (4). The second model generating unit 133 uses an algorithm that is used in machine learning as the algorithm used in the learning process. For example, the second model generating unit 133 uses a classification tree, a regression tree, discrimination analysis, a k-nearest neighbor, a naive Bayes classifier, or a support vector machine, for example, as the algorithm.

For example, in the example illustrated in FIG. 1, the left-hand side of Equation (4) is calculated as “1” for the user “A”. With the left-hand side of Equation (4) substituted by the value for the user “A”, the resultant equation will be “1=w′₁×1+w′₂×1+w′₃×0+ . . . ”. With the left-hand side of Equation (4) substituted by the value for the user “B”, the resultant equation will be “1=w′₁×0+w′₂×1+w′₃×1+ . . . ”. With the left-hand side of Equation (4) substituted by the value for the user “C”, the resultant equation will be “1=w′₁×1+w′₂×1+w′₃×0+ . . . ”. In this manner, the second model generating unit 133 acquires a combination of the weights “w′₁” to “w′_{n′}” that satisfies the equations resultant of substituting the variables in Equation (4) by the second information on each of the users included in the correct answer information.

The second model generating unit 133 generates the second model through the learning process described above. Specifically, as indicated in the second model T105 illustrated in FIG. 1, the second model generating unit 133 generates a combination of weights for the prediction target “graduation ceremony”, in which the weight of the feature “query A” is “0.8”, the weight of the feature “query B” is “1.2”, the weight of the feature “query C” is “0.5”, and the weight of the feature “query D” is “0.1”, as the second model. The second model generating unit 133 may also generate the second model by performing the learning process using three or more values, without limitation to the binary taking a value of either 0 or 1 indicating the presence. For example, the second model generating unit 133 may also generate the second model by performing the learning process based on the scores in the correct answer information T103.

Predicting Unit 134

The predicting unit 134 predicts a response of a second user to an affair based on the second model and the second information. For example, the predicting unit 134 predicts whether the second user has a prediction target based on the second model and the second information. In the example illustrated in FIG. 1, the predicting unit 134 generates the prediction information T106 based on the second model T105 and the second information T104. The following explanation will be provided using the second model T105, the second information T104, and the prediction information T106 illustrated in FIG. 1 as an example. The predicting unit 134 calculates the prediction information using Equation (5) below.

$${y}^{′} = {\sum }_{i = 1}^{{n}^{′}} {w}_{i}^{′} \times {x}_{i}^{′} \qquad ( 5 )$$

“w′ᵢ” and “x′ᵢ” on the right-hand side of Equation (5) are the same as those in Equation (4).

For example, the predicting unit 134 generates prediction information for the second users who are not the first users. For example, in the example illustrated in FIG. 1, the predicting unit 134 generates prediction information for the user “X” who is included in the first users.

In the second information T104 illustrated in FIG. 1, the user “X” is registered with a history of searches executed with search queries having the feature “query A” corresponding to “x′₁”, and the feature “query D” corresponding to “x′₄”. Therefore, the score for the user “X” is calculated as “y′=0.8×1+1.2×0+0.5×0+0.1×1+ . . . ”, by substituting the variables in Equation (5) with the actual values. For example, in the example illustrated in FIG. 1, the score for the user “X” is calculated as “2.7”.

The predicting unit 134 may also generate the information indicating the presence of the prediction target by substituting “y” in Equation (3) with the score calculated for the user “X” by Equation (5) (the value of “y′”). Specifically, as illustrated in the prediction information T106 in FIG. 1, the predicting unit 134 may generate “1” indicating that the user “X” has the prediction target as the prediction information.

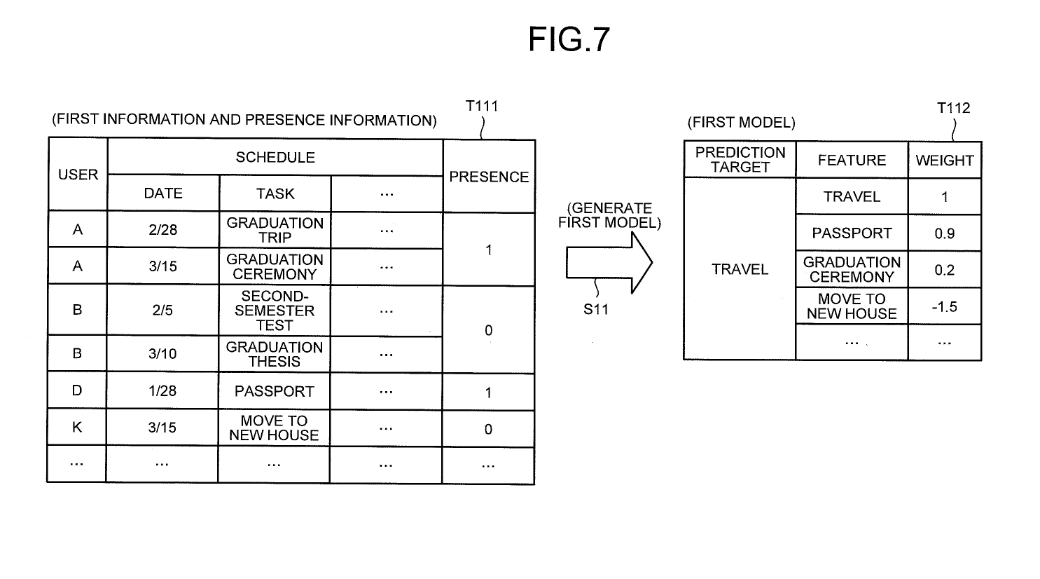

Explained now with reference to FIG. 7 is how the first model generating unit 131 generates the first model using the first information in the embodiment. FIG. 7 is a schematic illustrating an example of a first model generating process according to the embodiment. The first model generating unit 131 generates the first model based on the first information related to the first users whose response to an affair has been determined. In the example illustrated in FIG. 7, the first model generating unit 131 generates the first model based on the first information, and the information indicating whether each of the first users corresponding to the first information has the prediction target (Step S11). Specifically, the first model generating unit 131 generates the first model for predicting whether a user will go acting on an affair “travel” that is a prediction target based on the first information, and the information indicating whether each of the first users corresponding to the first information has the prediction target.

In the example illustrated in FIG. 7, first information T111 includes the first information that is the calendar information, and presence information indicating whether the corresponding user has a plan to travel, the travel being a prediction target. Hereinafter, the presence of the travel that is the prediction target is sometimes referred to as a prediction target “travel”. In the example illustrated in FIG. 7, it is assumed that the first model generating unit 131 has generated the first model on January 1, and the prediction target “travel” indicates whether the user has a plan to travel within three months from the date on which the model has been generated (January 1).

If the user has a plan to travel, the information indicating the presence of the prediction target will be “1”. If the user does not have a plan to travel, the information indicating the presence of the prediction target will be “0”. In the example illustrated in FIG. 7, the user “A” and the user “D” are specified with “1” as the information indicating the presence of the prediction target, and are the users who have a plan to travel. The user “B” and the user “K” are specified with “0” as the information indicating the presence of the prediction target, and are users who do not have a plan to travel. The first information T111 illustrated in FIG. 7 includes only the first users to whom the information indicating the presence of the prediction target is mapped, but the first users may also include users to whom the information indicating the presence of the prediction target is not mapped, e.g., the user “C”.

For example, the first model generating unit 131 may generate the information indicating the presence of the prediction target, for users for which the presence of such a prediction target can be determined. For example, the first model generating unit 131 may determine the user “A” as a user having the prediction target “travel” because the user “A” is registered with a task “graduation trip” on February 28. For example, the first model generating unit 131 may also determine the user “D” as a user having the prediction target “travel” because the user “D” is registered with a task “passport” on January 28. In this manner, the first model generating unit 131 may determine a user who has a task that is highly correlated with the presence of the prediction target “travel” as a user having the prediction target.

The first model generating unit 131 may also determine the user “B” as a user who does not have the prediction target “travel”, for example, because the user “B” is registered with a task “second-semester test” on February 5, and with a task “graduation thesis” on March 10. The first model generating unit 131 may also determine the user “K” as a user not having the prediction target “travel”, for example, because the user “K” is registered with a task “moving to new house” on March 15. In this manner, the first model generating unit 131 may determine the user having a task highly correlated with the absence of the prediction target “travel”, as a user not having the prediction target.

As described above, the first model generating unit 131 may determine a user having a specific task as a user having the prediction target, and determine a user having another specific task as a user not having the prediction target. In other words, the first model generating unit 131 may generate the information indicating the presence of the prediction target for users for which the presence of the prediction target can be determined based on some conditions. The predicting apparatus 100 may also acquire the information indicating the presence of the prediction target from an external information processing apparatus. The predicting apparatus 100 may also have a user enter the information indicating the presence of the prediction target, for example. The information indicating the presence of the prediction target may also be a score. The first model generating unit 131 calculates the first model based on Equation (2) mentioned above.

“x₁” to “xₙ” in Equation (2) are assigned with “1” if the user has the corresponding feature, and are assigned with “0” if the user does not have the corresponding feature. For example, in the example illustrated in FIG. 7, “x₁” indicates whether the first information T111 of the corresponding user includes a task “travel”, and “x₂” indicates whether the first information T111 of the corresponding user includes a task “passport”. “x₃” indicates whether the first information T111 of the corresponding user has a “graduation ceremony”.

In Equation (2), “w₁” to “wₙ” represent the weights given to “x₁” to “xₙ”, respectively. In the example illustrated in FIG. 7, “w₁” represents the weight given to “x₁ (travel)”, and “w₂” represents the weight given to “x₂ (passport)”. “w₃” represents the weight given to “x₃ (graduation ceremony)”.

The first model generating unit 131 generates the first model through the learning process. Specifically, the first model generating unit 131 acquires a combination of the weights “w₁” to “wₙ” satisfying Equation (2). The first model generating unit 131 uses an algorithm that is used in machine learning as the algorithm used in the learning process. For example, the first model generating unit 131 uses a classification tree, a regression tree, discrimination analysis, a k-nearest neighbor, a naive Bayes classifier, or a support vector machine, for example, as the algorithm.

For example, in the example illustrated in FIG. 7, for the user “A”, “y” in the left-hand side of Equation (2) is substituted by “1” indicating the presence of the prediction target. With “y” in Equation (2) substituted by the value for the user “A”, the resultant equation will be “1=w₁×0+w₂×0+w₃×1+w₄×0+ . . . ”. With “y” in Equation (2) substituted by the value for the user “B”, the resultant equation will be “0=w₁×0+w₂×0+w₃×0+w₄×0+ . . . ”. With “y” in Equation (2) substituted by the value for the user “D”, the resultant equation will be “1=w₁×0+w₂×1+w₃×0+w₄×0+ . . . ”. With “y” in Equation (2) substituted by the value for the user “K”, the resultant equation will be “0=w₁×0+w₂×0+w₃×0+w₄×1+ . . . ”. In this manner, the first model generating unit 131 acquires a combination of the weights “w₁” to “wₙ” that satisfies the equations resultant of substituting “y” in Equation (2) with the first information on the first users whose response to the affair has been determined.

The first model generating unit 131 generates the first model through the learning process. Specifically, as illustrated in a first model T112 in FIG. 7, the first model generating unit 131 generates a combination of weights, for the prediction target “travel”, in which the feature “travel” has a weight of “1”, the feature “passport” has a weight of “0.9”, the feature “graduation ceremony” has a weight of “0.2”, and the feature “moving to new house” has a weight of “−1.5”, for example, as the first model. The first model generating unit 131 may generate the first model by performing a learning process using three or more values, without limitation to the binary taking a value of either 0 or 1 indicating the presence.

3. Prediction Process

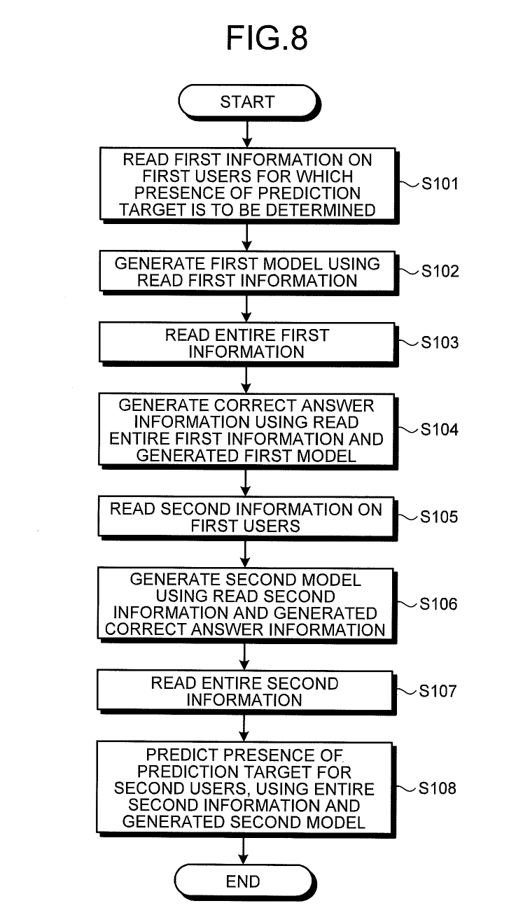

The prediction process performed by the predicting apparatus 100 according to the embodiment will now be explained with reference to FIG. 8. FIG. 8 is a flowchart illustrating the prediction process performed by the predicting apparatus 100 according to the embodiment.

As illustrated in FIG. 8, the first model generating unit 131 in the predicting apparatus 100 reads the first information on a first user for which the presence of the prediction target is to be determined (Step S101). The first model generating unit 131 then generates the first model using the read first information (Step S102). When the first model is to be acquired from the external, the predicting apparatus 100 does not need to perform the process at Steps S101 and S102.

The correct answer generating unit 132 in the predicting apparatus 100 reads the entire first information (Step S103). The correct answer generating unit 132 then generates the correct answer information using the entire first information and the generated first model (Step S104). The entire first information herein means the first information used for generating the correct answer information, for example, and is the entire information used for generating the correct answer information, among the pieces of information stored in the first information storage unit 121 illustrated in FIG. 3.

The second model generating unit 133 in the predicting apparatus 100 then reads the second information on the first users (Step S105). The second model generating unit 133 then generates the second model using the read second information and the generated correct answer information (Step S106).

The predicting unit 134 in the predicting apparatus 100 then reads the entire second information (Step S107). The predicting apparatus 100 then predicts the presence of the prediction target for each of the second users using the entire second information and the generated second model (Step S108). The entire second information herein means the second information used for generating the correct answer information, for example, and means the information used for predicting the presence of the prediction target, among the pieces of information stored in the second information storage unit 123 illustrated in FIG. 5. The predicting apparatus 100 may, for example, read only the second information related to a user for which a prediction is made using the second information, at Step S107.

4. Modifications

The predicting apparatus 100 according to the embodiment may be implemented in various different ways other than that according to the embodiment described above. Some other embodiments of the predicting apparatus 100 will now be explained.

4-1. Prediction Process

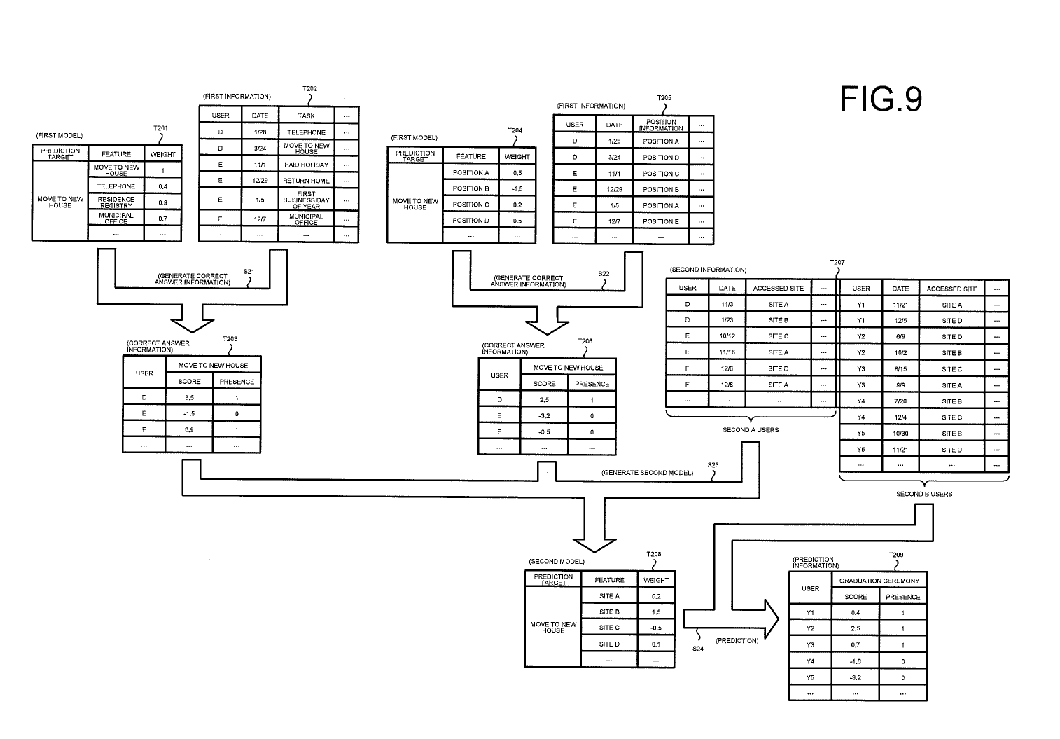

In the embodiment described above, the predicting apparatus 100 generates the correct answer information, and generates the second model based on one type of the first information. However, the predicting apparatus 100 may also generate a plurality of pieces of correct answer information based on a plurality of types of the first information, and generate the second model. Such an example will now be explained with reference to FIG. 9. FIG. 9 is a schematic illustrating an example of the prediction process according to the modification. Descriptions that are the same as those in the embodiment will be omitted herein.

In the example described below, the predicting apparatus 100 uses two different types of first information that are calendar information that is the information related to the schedule of user's activities, and the history of user position information (hereinafter, referred to as “position log information”). Explained with reference to FIG. 9 is an example in which two first models are generated in advance, such models corresponding to the calendar information and the position log information that are the two types of first information, respectively. The predicting apparatus 100 also uses the information related to the history of sites accessed by the users as the second information (hereinafter, referred to as “access log information”). The position information can be collected using various types of technologies, an example of which includes the use of a function such as global positioning system (GPS) or a beacon.

Explained now with reference to FIG. 9 is an example in which the prediction target is moving to a new house. In the example described below, the presence of an action of a user that is moving to a new house, the moving being the prediction target, is the prediction target, and the predicting apparatus 100 predicts the presence of the action, that is, predicts a response to the prediction target. In other words, if the user moves to a new house, the action is present. If the user does not move to a new house, the action is absent. Hereinafter, the presence of the action “moving to new house” that is to be a prediction target is sometimes referred to as a prediction target “moving to new house”. The predicting apparatus 100 may establish a predetermined time period for the prediction target. For example, the predicting apparatus 100 may consider the presence of the action “moving to new house” occurring within a half a year from the date on which the second models are generated as the prediction target “moving to new house”.

Explained with reference to FIG. 9 is an example in which the predicting apparatus 100 predicts whether the second users from whom only the search log information is collected, that is, the second B users are the users who will move to a new house, based on the information on the first users whose calendar information and position log information are collected.

To begin with, the predicting apparatus 100 generates the correct answer information based on the calendar information that is a first type of the first information and the first model corresponding to the calendar information (Step S21). In the example illustrated in FIG. 9, the predicting apparatus 100 generates the correct answer information T203 based on the first model T201 generated in advance and the first information T202. The predicting apparatus 100 then generates the correct answer information based on the position log information that is a second type of the first information and the first model corresponding to the position log information (Step S22). In the example illustrated in FIG. 9, the predicting apparatus 100 generates the correct answer information T206 based on the first model T204 generated in advance and the first information T205. In the example illustrated in FIG. 9, the first information T205 is the calendar information, and includes information such as user names, dates indicating a schedule, and position information.

In the example illustrated in FIG. 9, the predicting apparatus 100 determines that the prediction target “moving to new house” is present if the score is greater than zero, and determines that the prediction target “moving to new house” is absent if the score is less than zero. In the correct answer information T203 and the correct answer information T206, the presence “1” indicates the presence of the prediction target, and the presence “0” indicates the absence of the prediction target. In other words, in the correct answer information T203 and the correct answer information T206, a user with the presence “1” is a user who is expected to move to a new house, and a user with the presence “0” is a user who is not expected to move to a new house.

In the example illustrated in FIG. 9, the user “F” is determined to have a prediction target “moving to new house” in the correct answer information T203, and is determined not to have the prediction target “moving to new house” in the correct answer information T206. In the example illustrated in FIG. 9, the predicting apparatus 100 handles the subsequent process considering a user determined to have a prediction target “moving to new house” in any one of the pieces of the correct answer information as a user having the prediction target “moving to new house”, but the details of this process will be described later.

The predicting apparatus 100 then generates the second model based on a plurality of pieces of the correct answer information and the second information (Step S23). Specifically, the predicting apparatus 100 generates the second model based on the pieces of correct answer information and the second information corresponding to the second A users. In the example illustrated in FIG. 9, the predicting apparatus 100 generates the second model T208 based on the correct answer information T203 generated at Step S21, the correct answer information T206 generated at Step S22, and the second information T207. In the example illustrated in FIG. 9, the second information T207 is the access log information, and includes information such as user names, dates on which some sites are accessed, and the accessed sites. In the example illustrated in FIG. 9, the second model T208 generated at Step S23 maps the prediction target “moving to new house” to each of the accessed sites as a feature, and includes a weight indicating a degree of impact that each of the sites has on the prediction target “moving to new house”. In other words, the predicting apparatus 100 derives a weight indicating a degree of impact that the accessed site which is the feature has on the prediction target “moving to new house” through the learning process, based on the two correct answer information T203 and the correct answer information T206, and the second information T207.

At this time, the predicting apparatus 100 generates the second model using the second information on the users corresponding to the correct answer information, that is, the second information on the first users. For example, the predicting apparatus 100 generates the second model T208 based on the correct answer information and the second information T207 corresponding to the users D, E, F, and so on. As described above, in the example illustrated in FIG. 9, because the user “F”, too, is determined to be a user having the prediction target “moving to new house”, the predicting apparatus 100 performs the learning process rendering the user “D” and the user “F” as users having the prediction target “moving to new house”, and the user “E” as a user not having the prediction target “moving to new house”, and generates the second model T208. The predicting apparatus 100 generates the second model T208 excluding the information on users Y1 to Y5, for example, who are not included in the first users from the second information T207. In other words, the predicting apparatus 100 generates the second model T208 using the second information T207 corresponding to the second A users.

The second model T208 generated at Step S23 includes the identities (accessed sites) mapped to the prediction target “moving to new house”, and a weight indicating a degree of impact that each of the identities has on the prediction target “moving to new house”. For example, in the example illustrated in FIG. 9, a feature “site A” has a weight of “0.2”, and a feature “site B” has a weight of “1.5”.

The predicting apparatus 100 then generates the prediction information T209 for predicting whether each of the second users corresponding to the second information T207 has the prediction target “moving to new house”, using the second model T208 (Step S24). In the example illustrated in FIG. 9, the predicting apparatus 100 generates the prediction information T209 for predicting whether the second B users have the prediction target “moving to new house” using the second model T208. For example, the predicting apparatus 100 generates the prediction information T209 for predicting whether the user Y1 has the prediction target “moving to new house” based on the second information T207 corresponding to the user Y1, and the second model T208. Specifically, the sites accessed by the user Y1 include the feature “site A” and the feature “site D”, and therefore, the score for the user Y1 can be calculated as “0.2+0.1+ . . . =0.4”. In the example illustrated in FIG. 9, the predicting apparatus 100 determines that the prediction target “moving to new house” is present if the score is greater than zero, and determines that the prediction target “moving to new house” is absent if the score is less than zero. In the prediction information T209, if the score is greater than zero, the user “Y1” is determined to have a prediction target “moving to new house”. The predicting apparatus 100 also generates the prediction information T209 for predicting whether each of the users Y2 to Y5 who are the other second B users has the prediction target “moving to new house”.

4-2. Calculating Scores in Correct Answer Information

In this modification, the correct answer generating unit 132 generates the correct answer information for each of the pairs of the first information and the first model. In the example illustrated in FIG. 9, the correct answer generating unit 132 generates the correct answer information T203 based on the first model T201 and the first information T202, and generates the correct answer information T206 based on the first model T204 and the first information T205. For example, the correct answer generating unit 132 calculates the scores in the correct answer information T203 based on the first model T201 and the first information T202, using Equation (6) below.

$$y\_ 1 = {\sum }_{i = 1}^{n\_ 1} w\_ {1}_{i} \times x\_ {1}_{i} \qquad ( 6 )$$

Each of “x_1₁” to “x_1ₙ_{_}₁” in Equation (6) indicates whether the first information corresponding to the first users includes the corresponding feature, as a value. n_1 corresponds to the number of identities included in the first model T201. Each of “x_1₁” to “x_1ₙ_{_}₁” in Equation (6) is assigned with “1” if the first information includes the corresponding feature, and is assigned with “0” if the first information does not include the corresponding feature. For example, “x_1₁” indicates whether the first information T202 of the corresponding user includes the task “moving to new house”. “x_1₂” indicates whether the first information T202 of the corresponding user includes a task “telephone”, and “x_1₃” indicates whether the first information T202 of the corresponding user includes a task “residence registry”.

“w_1₁” to “w_1ₙ_{_}₁” in Equation (6) represent the weights given to “x_1₁” to “x_1ₙ_{_}₁”, respectively. For example, “w_1₁” represents the weight given to “x_1₁ (move to a new house)”. “w_1₂” represents the weight given to “x_1₂ (telephone)”, and “w_1₃” represents the weight given to “x_1₃ (residence registry)”.

For example, in the first information T202 illustrated in FIG. 9, the user “D” is registered with a task corresponding to the feature “moving to new house” corresponding to “x_1₁” and another task corresponding to the feature “telephone” corresponding to the “x_1₂”.

Therefore, the score for the user “D” is calculated as “y_1=1×1+0.4×1+0.9×0+ . . . ”, by substituting the variables in Equation (6) with the actual values. For example, in the example illustrated in FIG. 9, the score for the user “D” is calculated as “y_1=3.5”. The score for the user “E” is calculated as “y_1=−1.5”, and the score for the user “F” is calculated as “y_1=0.9”.

The correct answer generating unit 132 also generates the correct answer information T203 including the information indicating the presence of the prediction target based on the scores calculated by Equation (6). The correct answer generating unit 132 generates the correct answer information T203 including the information indicating the presence of the prediction target using Equation (3).

The correct answer generating unit 132 also calculates, for example, the scores for the correct answer information T206 based on the first model T204 and the first information T205, using Equation (7) below.

$$y\_ 2 = {\sum }_{i = 1}^{n\_ 2} w\_ {2}_{i} \times x\_ {2}_{i} \qquad ( 7 )$$

Each of “x_2₁” to “x_2ₙ_{_}₂” in Equation (7) indicates whether the first information corresponding to each of the first users includes the corresponding feature, as a value. n_2 corresponds to the number of identities included in the first model T204. Each of “x_2₁” to “x_2ₙ_{_}₂” in Equation (7) is assigned with “1” if the first information includes the corresponding feature, and is assigned with “0” if the first information does not include the corresponding feature. For example, “x_2₁” indicates whether the first information T205 of the corresponding user includes the position information “position A”, and “x_2₂” indicates whether the first information T205 of the corresponding user includes position information “position B”. “x_2₃” indicates whether the first information T205 of the corresponding user includes position information “position C”.

“w_2₁” to “w_2ₙ₂” in Equation (7) represent the weights given to “x_2₁” to “x_2ₙ_{_}₂”, respectively. For example, “w_2₁” represents the weight given to “x_2₁ (position A)”, “w_2₂” represents the weight given to “x_2₂ (position B)”, and “w_2₃” represents the weight given to “x_2₃ (position C)”.

For example, in the first information T205 illustrated in FIG. 9, the user “D” is registered with the position information having the feature “position A” corresponding to “x_2₁”, and with another position information having the feature “position B” corresponding to “x_2₂”. Therefore, the score for the user “D” can be calculated as “y_2=0.5×1+1.5×1+0.2×0+0.5×1+ . . . ”, by substituting the variables in Equation (7) with the actual values. For example, in the example illustrated in FIG. 9, the score for the user “D” is calculated as “y_2=2.5”. The score for the user “E” is calculated as “y_2=−3.2”, and the score for the user “F” is calculated as “y_2=−0.5”.

The correct answer generating unit 132 also generates the correct answer information T206 including the information indicating the presence of the prediction target based on the scores calculated by Equation (7). The correct answer generating unit 132 generates the correct answer information T206 including the information indicating the presence of the prediction target based on Equation (3) mentioned above.

4-3. Integration of Correct Answer Information

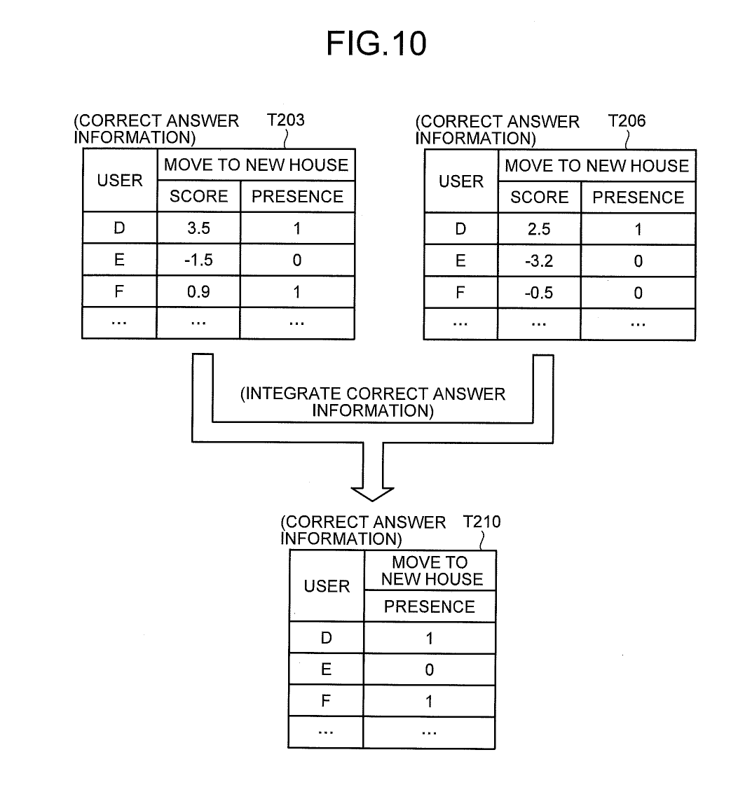

In this modification, the correct answer generating unit 132 integrates the generated pieces of correct answer information. This integration will now be explained with reference to FIGS. 10 to 13. FIGS. 10 to 13 are schematic illustrating examples of how the pieces of correct answer information are integrated in the modification. This integration will be explained using the correct answer information T203 and T206, the second information T207, and the second model T208 illustrated in FIG. 9 as an example.

In the example illustrated in FIG. 10, when the number of “1”s specified as the presence of the prediction target for the corresponding user in the pieces of correct answer information is equal to or greater than the number of “0”s, the prediction target will be assigned with the presence “1” in the correct answer information T210 resultant of integrating the correct answer information T203 and the correct answer information T206. In other words, when a user has a presence “1” for the prediction target at least one of the correct answer information T203 and the correct answer information T206 in the example illustrated in FIG. 10, the correct answer information T210 resultant of the integration will be assigned with the presence “1” for the prediction target. Specifically, in the example illustrated in FIG. 10, because the user “D” has the presence “1” for the prediction target in both of the correct answer information T203 and the correct answer information T206, the user “D” will be assigned with the presence “1” for the prediction target in the correct answer information T210 resultant of the integration. Because the user “E” has the presence “0” for the prediction target in both of the correct answer information T203 and the correct answer information T206, the user “E” will be assigned with the presence of the prediction target “0” in the correct answer information T210 resultant of the integration. Because the user “F” has the presence “1” for the prediction target in the correct answer information T203, and has the presence of the prediction target “0” in the correct answer information T206, the user “F” will be assigned with the presence “1” for the prediction target in the correct answer information T210 resultant of the integration.

The second model generating unit 133 then generates the second model based on the correct answer information integrated by the correct answer generating unit 132 and the part of the second information related to the users included in the correct answer information. In other words, the second model generating unit 133 generates the second model based on the correct answer information T210 resultant of the integration. It is also possible to have the second model generating unit 133 integrate the correct answer information.

At this time, the second model generating unit 133 calculates the second model using Equation (8) below.

$$sgn ( sgn ( {\sum }_{i = 1}^{n\_ 1} w\_ {1}_{i} \times x\_ {1}_{i} ) + sgn ( {\sum }_{j = 1}^{n\_ 2} w\_ {2}_{j} \times x\_ {2}_{j} ) ) = {\sum }_{k = 1}^{{n}^{′}} {w}_{k}^{′} \times {x}_{k}^{′} \qquad ( 8 )$$

The left-hand side of Equation (8) corresponds to the integration of the correct answer information described above. Specifically, the value of the left-hand side of Equation (8) corresponds to the presence of the prediction target in the correct answer information T210 resultant of the integration.

Each of “x′₁” to “x′_{n′}” on the right-hand side of Equation (8) indicates, as a value, whether the corresponding feature is included in the second information corresponding to each of the users included in the correct answer information. Each of “x′₁” to “x′_{n′}” in Equation (8) is assigned with “1” if the second information includes the corresponding feature, and is assigned with “0” if the second information includes the corresponding feature. For example, “x′₁” indicates whether the second information T207 of the corresponding user includes the accessed site “site A”. “x′₂” indicates whether the second information T207 of the corresponding user includes the accessed site “site B”, and “x′₃” indicates whether the second information T207 of the corresponding user includes the accessed site “site C”. Each of “x′₁” to “x′_{n′}” may also be assigned with the number of times the corresponding feature (site) is accessed.

“w′₁” to “w′_{n′}” in Equation (8) represent the weights given to “x′₁” to “x′_{n′}”, respectively. For example, “w′₁” represents the weight given to “x′₁ (site A)”. “w′₂” represents the weight given to “x′₂ (site B)”, and “w′₃” represents the weight given to “x′₃ (site C)”.

The second model generating unit 133 generates the second model through the learning process. Specifically, the second model generating unit 133 acquires a combination of the weights “w′₁” to “w′_{n′}” satisfying Equation (8). For example, the examples illustrated in FIGS. 9 and 10, with the variables in Equation (8) substituted by the actual values corresponding to the user “D”, the resultant equation will be “1=w′₁×1+w′₂×1+w′₃×0+ . . . ”. With the variables in Equation (8) substituted by the actual values corresponding to the user “E”, the resultant equation will be “0=w′₁×1+w′₂×0+w′₃×1+ . . . ”. With the variables in Equation (8) substituted by the actual values corresponding to the user “F”, the resultant equation will be “1=w′₁×1+w′₂×0+w′₃×0+ . . . ”. In this manner, the second model generating unit 133 acquires a combination of the weights “w′₁” to “w′_{n′}” that satisfies the equations resultant of substituting the left-hand side of Equation (8) with the second information on each of the users included in the correct answer information.

The second model generating unit 133 generates the second model through the learning process. For example, in the example illustrated in FIGS. 9 and 10, the second model generating unit 133 generates a combination of weights in which the feature “site A” has a weight of “0.2”, the feature “site B” has a weight of “1.5”, the feature “site C” has a weight of “−0.5”, and the feature “site D” has a weight of “0.1”, for the prediction target “moving to new house”, as presented in the second model T208.

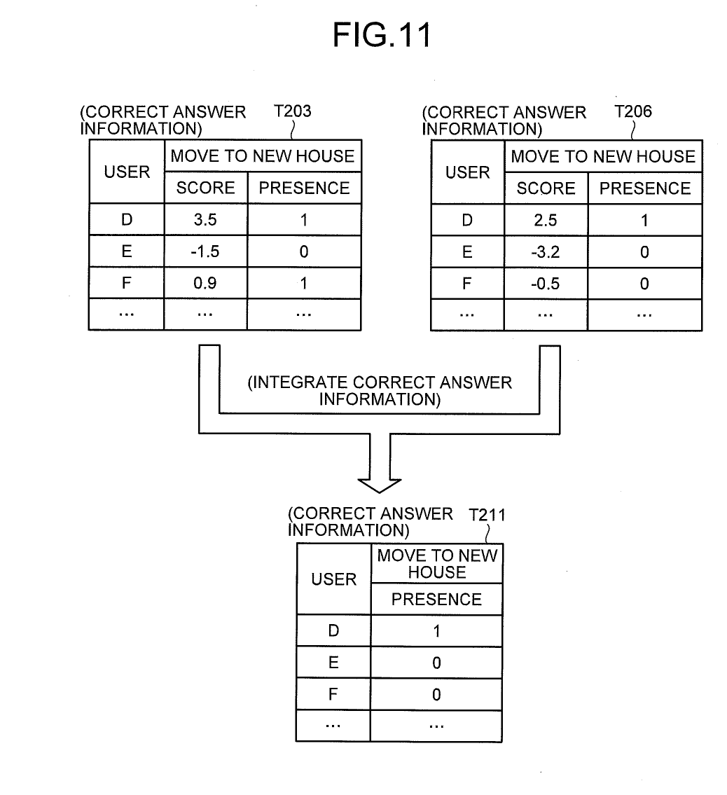

In the example illustrated in FIG. 11, if a user is assigned with the presence “1” for the prediction target in all of the pieces of correct answer information, the correct answer information T203 and the correct answer information T206 are integrated into the correct answer information T211 specifying the presence “1” for the prediction target for the user. In other words, for the user having the presence “0” for the prediction target in at least one of the correct answer information T203 and the correct answer information T206 in the example illustrated in FIG. 11, the correct answer information T211 resultant of the integration has the presence “0” for the prediction target. Specifically, in the example illustrated in FIG. 11, because the user “D” has the presence “1” for the prediction target in both of the correct answer information T203 and the correct answer information T206, the user “D” will be assigned with the presence “1” for the prediction target in the correct answer information T211 resultant of the integration. Because the user “E” has the presence “0” for the prediction target in both of the correct answer information T203 and the correct answer information T206, the user “E” will be assigned with the presence of the prediction target “0” in the correct answer information T211 resultant of the integration. Because the user “F” has the presence “1” for the prediction target in the correct answer information T203, and has the presence of the prediction target “0” in the correct answer information T206, the user “F” will be assigned with the presence of the prediction target “0” in the correct answer information T211 resultant of the integration.

The second model generating unit 133 then generates the second model based on the correct answer information integrated by the correct answer generating unit 132 and the part of the second information related to the users included in the correct answer information. In other words, the second model generating unit 133 generates the second model based on the correct answer information T211 resultant of the integration.

At this time, the second model generating unit 133 calculates the second model using Equation (9) below.

$$sgn ( sgn ( {\sum }_{i = 1}^{n\_ 1} w\_ {1}_{i} \times x\_ {1}_{i} ) \times sgn ( {\sum }_{j = 1}^{n\_ 2} w\_ {2}_{j} \times x\_ {2}_{j} ) ) = {\sum }_{k = 1}^{{n}^{′}} {w}_{k}^{′} \times {x}_{k}^{′} \qquad ( 9 )$$

The left-hand side of Equation (9) corresponds to the integration of the correct answer information described above. Specifically, the value in the left-hand side of Equation (9) corresponds to the presence of the prediction target in the integrated correct answer information T211. The subsequent process is the same as that according to the example illustrated in FIG. 10, and therefore, an explanation thereof is omitted.

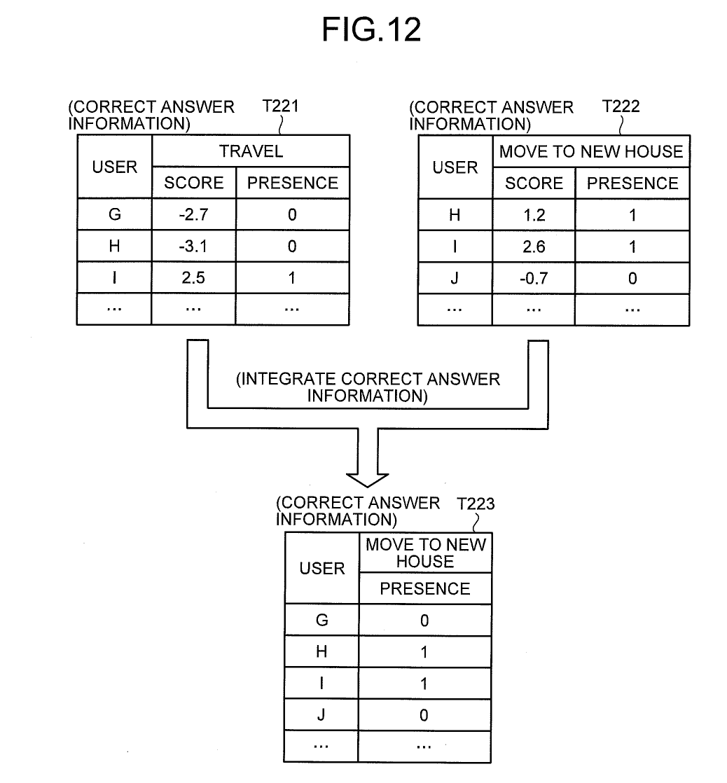

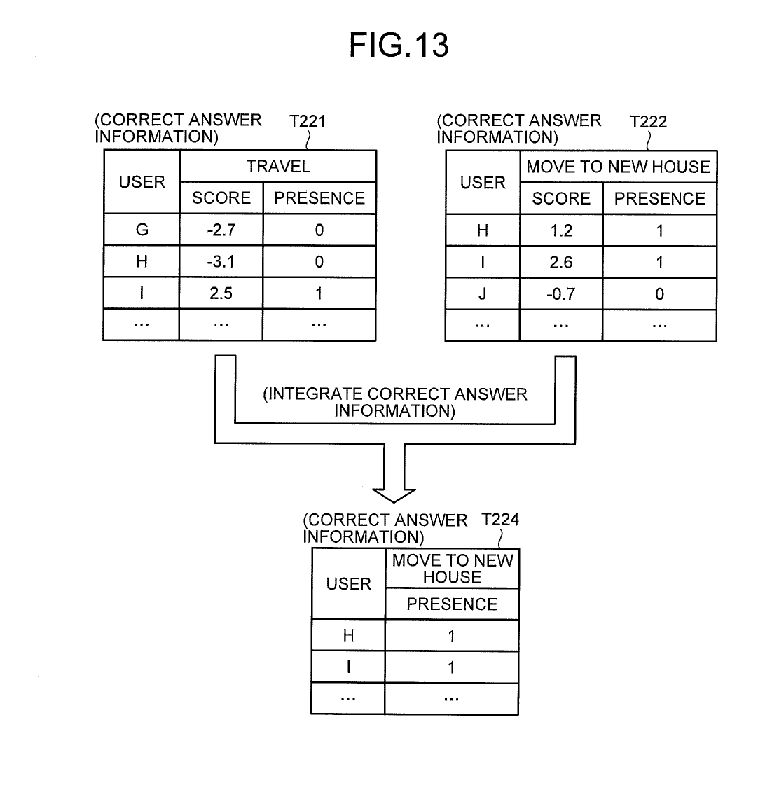

The correct answer generating unit 132 may integrate the pieces of the correct answer information even with different users included in the pieces of correct answer information. Such an example will now be explained with reference to FIGS. 12 and 13.

In the example illustrated in FIG. 12, the correct answer information T221 includes users G, H, and I, and the correct answer information T222 includes users H, I, and J. At this time, it is assumed that the correct answer information T221 does not include the user J, and the correct answer information T222 does not include the user G. In the example illustrated in FIG. 12, a user included in at least one of the pieces of correct answer information will be included in the correct answer information resultant of the integration. Specifically, the correct answer information T223 resultant of the integration includes the user G included only in the correct answer information T221 and the user J included in the correct answer information T222. In other words, the correct answer information T223 resultant of the integration includes the four users G, H, I, and J. The second model generating unit 133 then generates the second model based on the correct answer information T223 resultant of the integration.

In the example illustrated in FIG. 13, the correct answer information T221 and the correct answer information T222 are the same as those in FIG. 12. In the example illustrated in FIG. 13, however, only the users included in both pieces of the correct answer information are included in the correct answer information resultant of the integration. Specifically, the correct answer information T224 resultant of the integration does not include the user G included only in the correct answer information T221, and the user J included in the correct answer information T222. In other words, the correct answer information T224 resultant of the integration includes the two users H and I. The second model generating unit 133 then generates the second model based on the correct answer information T224 resultant of the integration. The correct answer generating unit 132 may include the users included a predetermined number or more pieces of correct answer information, in the correct answer information resultant of the integration.

In the example described above, two pieces of correct answer information are integrated, but any number of pieces of correct answer information that is equal to or greater than two may be integrated. The predicting apparatus 100 may also perform the prediction process using a plurality of second models. For example, the predicting apparatus 100 may perform the prediction process using a third model which is a combination of a plurality of second models.

4-4. Prediction Process

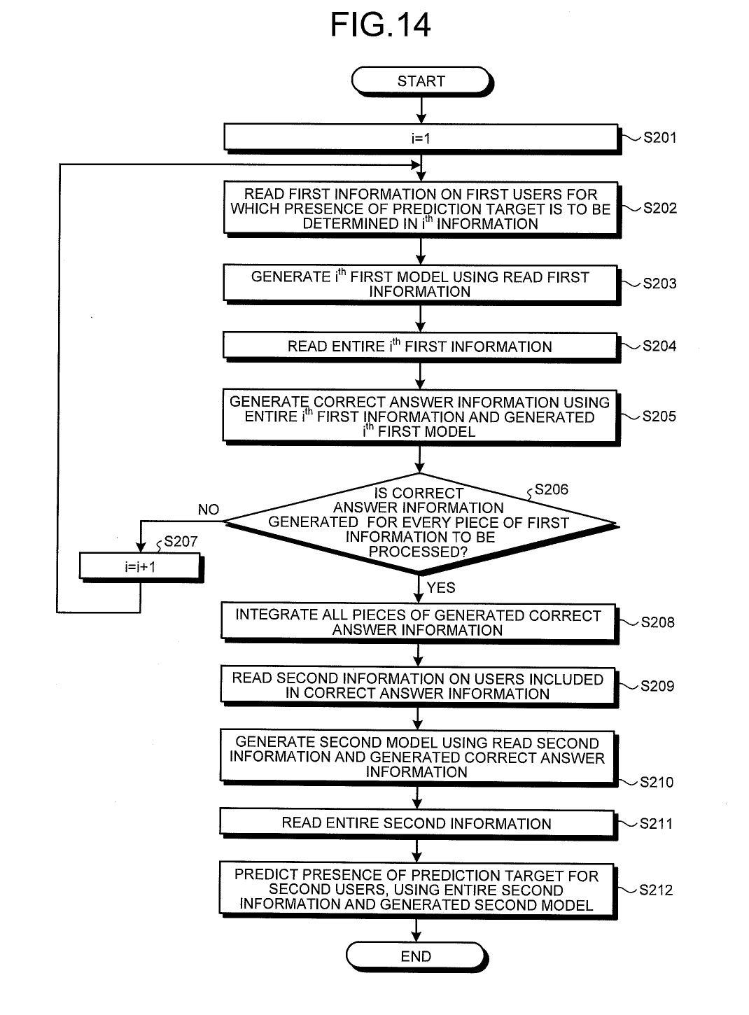

A prediction process performed by the predicting apparatus 100 according to the modification will now be explained with reference to FIG. 14. FIG. 14 is a flowchart illustrating an example of the prediction process according to the modification.

As illustrated in FIG. 14, the first model generating unit 131 in the predicting apparatus 100 according to the modification sets one to a variable i (Step S201). The first model generating unit 131 then reads the first information corresponding to the first users for which the presence of the action is to be determined in the i^{th} first information (Step S202). The first model generating unit 131 then generates the i^{th} first model using the read first information (Step S203). When the first model is to be acquired, the predicting apparatus 100 does not need to perform the process at Step S202 and S203.

The correct answer generating unit 132 in the predicting apparatus 100 then reads the entire i^{th} first information (Step S204). The correct answer generating unit 132 then generates the correct answer information using the entire i^{th} first information and the generated i^{th} first model (Step S205). The entire i^{th} first information means the i^{th} first information used for generating the correct answer information, and means the information used for generating the correct answer information, among the information stored in the first information storage unit 121 illustrated in FIG. 3, for example.

The correct answer generating unit 132 then determines whether the correct answer information has been generated for every piece of first information to be processed (Step S206). If the correct answer information has not been generated for every pieces of first information to be processed (No at Step S206), the correct answer generating unit 132 adds one to the variable i (Step S207), and returns to and repeats the process at Step S202.

If the correct answer information has been generated for every piece of first information to be processed (Yes at Step S206), the correct answer generating unit 132 integrates all of the pieces of the generated correct answer information (Step S208).

The second model generating unit 133 in the predicting apparatus 100 then reads the second information on the users included in the correct answer information (Step S209). The second model generating unit 133 then generates the second model using the read second information and the generated correct answer information (Step S210).

The predicting unit 134 in the predicting apparatus 100 then reads the entire second information (Step S211). The predicting apparatus 100 then predicts the presence of the prediction target for each of the second users using the entire second information and the generated second model (Step S212). The entire second information herein means the second information used for generating the correct answer information, and means the information used for predicting the presence of the prediction target, among the information stored in the second information storage unit 123 illustrated in FIG. 5, for example. At Step S211, for example, the predicting apparatus 100 may read only the second information related to the users for which a prediction is to be made using the second information.

4-5. Others

In the embodiment, the predicting apparatus 100 is explained to use different types of information for the first information and the second information, but the first information and the second information may be the same type of information. In such a case, the predicting apparatus 100 selects the first information based on a predetermined condition. When search log information is to be used, for example, the predicting apparatus 100 may use the information on queries consisting of a combination of keywords in a number equal to or greater than a predetermined number, or keyword including characters in a number equal to or greater than a predetermined number as the first information, and use the information on the other search queries as the second information. In this manner, the predicting apparatus 100 can generate the correct answer information using the information estimated to have a higher correlation with the prediction target as the first information even when the first information and the second information are the same type of information, and can predict a response to an affair of a second user having a lower correlation with the prediction target, highly accurately.

Furthermore, explained above is an example in which the prediction target is an action of a user, but any affair for which a prediction is to be made can be selected as a prediction target in a manner suitable or different purposes, without limitation to an action of a user. For example, the prediction target may be attribute information on a user. Specifically, the prediction process described above may be performed using the gender of a user as the prediction target.

For example, the predicting apparatus 100 may also generate the second model using the prediction target (given affair) as the gender of a user, using the information on the credit card purchase history as the first information, and using the search log information as the second information. In such a case, the predicting apparatus 100 can generate a model that can be used for determining the gender of a user from whom only the search log information can be acquired, highly accurately.

The first information may also be a history of purchases or accesses for online shopping, a history of bidding and winning bidding in an auction site or accesses to an auction site, a history of credit card payment information, a history of online reservations on and accesses to an accommodation or transportation site, for example, without limitation to the example described above. The first information may also be information related to a history of photographs posted on the Internet, information on social networking services (SNSes), information on emails or blogs, e.g., message information, information related to the number of user's steps that the user has walked, or information related to the physical characteristics (such as the weight) of the users. The first information may also be a combination of these types of information. Furthermore, various types of information may be selected as the second information as appropriate, depending on the prediction target, without limitation to the examples described above. For example, the second information may be a history of online researches, e.g., those using a transfer guide or a gourmet site. Furthermore, the second information may also be the information related to usage of an application, for example.

5. Advantageous Effects

As described above, the predicting apparatus 100 according to the embodiment includes the correct answer generating unit 132 and the second model generating unit 133. The correct answer generating unit 132 generates the correct answer information representing a response of each of the first targets to a given affair based on the first model that is to be used for predicting the response to the affair, and first information related to the first targets (in the embodiment, users, and the same applies hereunder). The second model generating unit 133 then generates a second model that is to be used for predicting a response of each of the second targets corresponding to the second information to the affair, the second information being information including the information on targets in addition to the information on the first targets, and having a lower correlation with the affair than the first information, based on the correct answer information generated by the correct answer generating unit 132, and on a part of second information related to the first targets.

In this manner, the predicting apparatus 100 according to the embodiment can generate a model that is to be used for predicting a response to a given affair, highly accurately. Specifically, the predicting apparatus 100 can generate a second model that is applicable to all of the second users corresponding to the second information, and capable of predicting a response to a prediction target highly accurately, by generating a second model using the correct answer information generated from the first information that is highly correlated with actions of the users. Therefore, the predicting apparatus 100 can generate a model to be used for predicting a response to the prediction target, highly accurately. The predicting apparatus 100 can also generate a model for enabling a highly accurate prediction of a response to a prediction target for users from whom the first information having a higher correlation with the prediction target cannot be collected, in other words, for the second users not included in the first users.

In the predicting apparatus 100 according to the embodiment, the correct answer generating unit 132 generates the correct answer information based on the first information having a smaller amount of information than the second information.

In this manner, the predicting apparatus 100 according to the embodiment can generate a model that is to be used for predicting a response to a given affair of each user corresponding to the second information having a larger amount of information, highly accurately, using the correct answer information generated based on the first information that is the information having a smaller amount of information.

Furthermore, in the predicting apparatus 100 according to the embodiment, the correct answer generating unit 132 uses a type of information that is different from the type of the first information, as the second information.

In this manner, the predicting apparatus 100 according to the embodiment can generate a model that is to be used for predicting a response to a given affair highly accurately, based on different types of information.

Furthermore, in the predicting apparatus 100 according to the embodiment, the correct answer generating unit 132 generates the correct answer information based on the first information that is related to the first targets satisfying a predetermined condition, among a predetermined type of information. The second model generating unit 133 then generates the second model using the predetermined type of information as the second information.

In this manner, the predicting apparatus 100 according to the embodiment can generate a model that is to be used for predicting a response to a given affair of a user from whom only the second information having a lower correlation with the affair has been collected highly accurately, based on the first information satisfying a predetermined condition, e.g., information having a high correlation with the affair.

Furthermore, in the predicting apparatus 100 according to the embodiment, the correct answer generating unit 132 generates the correct answer information based on the first information that is linked to the given affair that is a prediction target.

In this manner, the predicting apparatus 100 according to the embodiment can generate a model that is to be used for predicting a response to a given affair of each user corresponding to the second information highly accurately, using the correct answer information generated based on the first information that is linked to the given affair that is the prediction target. Specifically, when the first information is the information linked to the given affair that is the prediction target, the users from whom the first information can be collected is often more limited, compared with those from whom the second information can be collected. In other words, the number of second users from whom the information having a lower correlation with the prediction target can be collected is larger than the number of the first users from whom the information having a higher correlation with the prediction target can be collected. Therefore, by performing the learning based on the information on a smaller number of users from whom information linked to the given affair that is the prediction target can be collected and for whom a response to a prediction target can be predicted accurately, the predicting apparatus 100 can predict a response to prediction target of each of a larger number of users highly accurately, while such a prediction of the response has been rendered difficult.

The predicting apparatus 100 according to the embodiment is provided with the first model generating unit 131, and the first model generating unit 131 generates the first model based on the first information related to one or more targets a response of which to the affair has been determined, among the first targets.

In this manner, the predicting apparatus 100 according to the embodiment can generate the first model, and generate a model used for predicting a response to the given affair highly accurately. Furthermore, the predicting apparatus 100 can generate different first models suitable for the purposes.

Furthermore, in the predicting apparatus 100 according to the embodiment, the first model generating unit 131 generates the first model that is to be used for predicting a response to an affair that might occur in the future.

In this manner, the predicting apparatus 100 according to the embodiment can generate a model for predicting a response to an affair that might occur in the future, e.g., for predicting a response to a future action of a user, highly accurately.

Furthermore, in the predicting apparatus 100 according to the embodiment, the first model generating unit 131 generates the first model that is to be used for predicting a response to a determined affair.

In this manner, the predicting apparatus 100 according to the embodiment can generate a model that is to be used for predicting a response to a determined affair, e.g., the gender of a user or a past action of the user, highly accurately.

Furthermore, in the predicting apparatus 100 according to the embodiment, the first model generating unit 131 uses information related to the schedule of user's activities, or position information on the user, as the first information.

In this manner, the predicting apparatus 100 according to the embodiment can generate a model that is to be used for predicting a response to a given affair highly accurately, based on the information related to the schedule of user's activities such as calendar information or the position information on the user.

Furthermore, in the predicting apparatus 100 according to the embodiment, the second model generating unit 133 uses information related to the searches performed by a user as the second information.

In this manner, the predicting apparatus 100 according to the embodiment can generate a model that is to be used for predicting a response to a given affair for users from whom only the information related to the searches executed by the users can be collected, highly accurately.

Furthermore, the predicting apparatus 100 according to the embodiment is provided with the predicting unit 134, and the predicting unit 134 predicts a response of each of the second targets to the affair based on the second model and the second information.

In this manner, the predicting apparatus 100 according to the embodiment can also predict a response of a second user to the given affair, by using the generated second model. Therefore, the predicting apparatus 100 can also predict a response of each of the second users other than the first users to the prediction target highly accurately.

6. Hardware Configuration

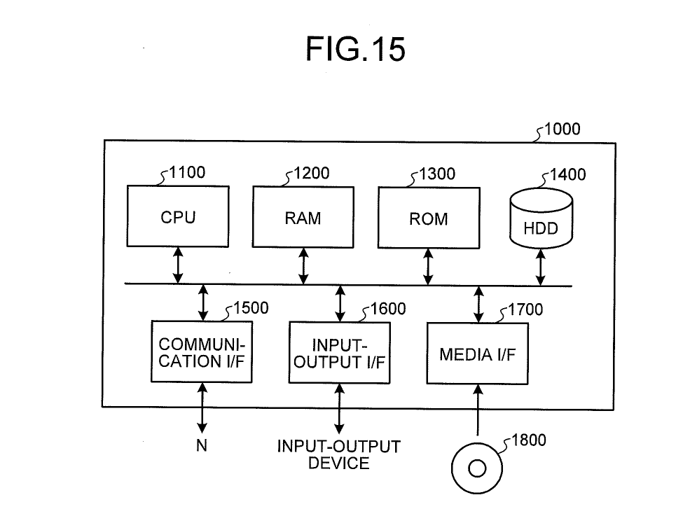

The predicting apparatus 100 according to the embodiment described above is implemented as a computer 1000 having a configuration illustrated in FIG. 15, for example. FIG. 15 is a schematic illustrating an exemplary hardware configuration of the computer 1000 implementing the functions of the predicting apparatus 100. The computer 1000 includes a central processing unit (CPU) 1100, a random access memory (RAM) 1200, a read-only memory (ROM) 1300, a hard disk drive (HDD) 1400, a communication interface (I/F) 1500, an input-output I/F 1600, and a media I/F 1700.

The CPU 1100 operates based on a computer program stored in the ROM 1300 or the HDD 1400, and controls each of the units. The ROM 1300 stores therein a boot program executed by the CPU 1100 when the computer 1000 is started, and a computer program that is dependent on the hardware of the computer 1000, for example.

The HDD 1400 stores therein computer programs executed by the CPU 1100 and the data used by the computer programs, for example. The communication I/F 1500 receives data from other devices over a given network N and forwards the data to the CPU 1100, and transmits the data generated by the CPU 1100 to another device over the given network N.

The CPU 1100 controls output devices such as a display and a printer, and input devices such as a keyboard and a mouse, via the input-output I/F 1600. The CPU 1100 acquires data from the input devices via the input-output I/F 1600. The CPU 1100 outputs generated data to the output devices via the input-output I/F 1600.

The media I/F 1700 reads a computer program or data stored in a recording medium 1800, and provides the computer program or the data to the CPU 1100 via the RAM 1200. The CPU 1100 loads the computer program from the recording medium 1800 onto the RAM 1200 via the media I/F 1700, and executes the loaded computer program. Examples of the recording medium 1800 include an optical recording medium such as a digital versatile disc (DVD) and a phase change rewritable disk (PD), a magneto-optical recording medium such as a magneto-optical (MO) disk, a tape medium, a magnetic recording medium, and a semiconductor memory.

When the computer 1000 functions as the predicting apparatus 100 according to the embodiment, for example, the CPU 1100 in the computer 1000 implements the function of the control unit 130 by executing computer programs loaded onto the RAM 1200. The CPU 1100 in the computer 1000 reads these computer programs from the recording medium 1800 before executing the computer programs, but may also acquire, as another example, these computer programs from another device over a given network N.

Although some embodiments of the present invention are explained in detail above with reference to the drawings, these embodiments are merely examples, and the present invention may also be implemented in any other embodiments with various modifications and improvements, based on the knowledge of those skilled in the art, in addition to the embodiments described in the disclosure of the present invention.

7. Others

The processes explained to be performed automatically in the embodiments may be performed manually, entirely or partly, or those explained to be performed manually in the embodiments may be performed automatically using a known method, entirely or partly. Furthermore, the steps of the processes, specific names, and information including various types of data and parameters described herein and the drawings may be changed in any manner, unless specified otherwise. For example, various pieces of information illustrated in the drawings are not limited to those illustrated in the drawings.

Furthermore, the elements of each of the apparatuses illustrated in the drawings are conceptual and functional representations, and do not necessarily need to be physically configured in the manner illustrated. In other words, specific configurations in which the apparatuses is distributed or integrated are not limited to those illustrated in the drawings, and may be configured, entirely or partly, to be distributed or integrated physically or functionally in any units, depending on various types of loads and utilization.

Furthermore, the embodiments described above may be combined as appropriate, within the scope in which the processes do not contradict one another.

The “units (section, module, unit)” described above may also be interpreted as “means” or a “circuit”. For example, the first model generating unit may be interpreted as first model generating means or a first model generating circuit.

One aspect of an embodiment has the advantage of accurately generating a model that is to be used for predicting a response to a given affair.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A learning apparatus comprising:
a correct answer generating unit that generates correct answer information representing a response of each of one or more first targets to a given affair, based on a first model that is to be used for predicting the response to the affair, and on first information related to the first targets; and
a second model generating unit that generates a second model that is to be used for predicting a response of each of one or more second targets corresponding to second information to the affair, the second information being information including information on one or more targets in addition to information on the first targets and having a lower correlation with the affair than the first information, based on the correct answer information generated by the correct answer generating unit, and on a part of the second information related to the first targets.

2. The learning apparatus according to claim 1, wherein the correct answer generating unit generates the correct answer information based on the first information having a smaller amount of information than the second information.

3. The learning apparatus according to claim 1, wherein the second model generating unit uses a type of information that is different from a type of the first information as the second information.

4. The learning apparatus according to claim 1, wherein
the correct answer generating unit generates the correct answer information based on the first information that is related to the first targets satisfying a predetermined condition, among a predetermined type of information, and
the second model generating unit generates the second model using the predetermined type of information as the second information.

5. The learning apparatus according to claim 1, wherein the correct answer generating unit generates the correct answer information based on the first information that is linked to the given affair that is a prediction target.

6. The learning apparatus according to claim 1, further comprising a first model generating unit that generates the first model based on the first information related to one or more targets a response of which to the affair has been determined, among the first targets.

7. The learning apparatus according to claim 6, wherein the first model generating unit generates the first model that is to be used for predicting a response to an affair that is possibly to occur in future.

8. The learning apparatus according to claim 6, wherein the first model generating unit generates the first model that is to be used for predicting a response to a determined affair.

9. The learning apparatus according to claim 1, further comprising a predicting unit that predicts a response of each of the second targets to the affair based on the second model and the second information.

10. A learning method executed by a computer, the learning method comprising:
generating correct answer information representing a response of each of one or more first targets to a given affair, based on a first model that is to be used for predicting the response to the affair, and on first information related to the first targets; and
generating a second model that is to be used for predicting a response of each of one or more second targets corresponding to second information to the affair, the second information being information including information on one or more targets in addition to information on the first targets and having a lower correlation with the affair than the first information, based on the correct answer information generated at the generating the correct answer information, and a part of the second information related to the first targets.

11. A non-transitory computer-readable storage medium with an executable program stored thereon, wherein the program instructs a computer to perform:
generating correct answer information representing a response of each of one or more first targets to a given affair, based on a first model that is to be used for predicting the response to the affair, and on first information related to the first targets; and
generating a second model that is to be used for predicting a response of each of one or more second targets corresponding to second information to the affair, the second information being information including information on one or more targets in addition to information on the first targets and having a lower correlation with the affair than the first information, based on the correct answer information generated at the generating the correct answer information, and a part of the second information related to the first targets.
